(19) United States
(12) Patent Application Publication
(10) Pub. No.: US 2015/0358207 A1
(43) Pub. Date: Dec. 10, 2015

(54) Method of Obtaining Optimized Use Case for Communication Network

(71) Applicant: Huawei Technologies Co., Ltd., Shenzhen (CN)

(72) Inventors: Andrew Martyn David Baldock, Shenzhen (CN); Jiann-Chin Dorng, Shenzhen (CN)

(21) Appl. No.: 14/828,219

(22) Filed: Aug. 17, 2015

Related U.S. Application Data
(63) Continuation of application No. PCT/CN2014/072165, filed on Feb. 17, 2014.
(60) Provisional application No. 61/765,733, filed on Feb. 17, 2013.

(51) Int. Cl. H04L 12/24; G06Q 10/10; H04L 12/26

(52) U.S. Cl. CPC H04L 41/0823; H04L 43/062; G06Q 10/10; H04L 41/145

(57) ABSTRACT

Method of Obtaining Optimized Use Case for Communication Network A method of obtaining an optimized combination of use cases for a communication network is disclosed. The method includes presenting on a display device a set of objectives, wherein at least one communication network indicator is associated with the set of objectives, and each of the set of objectives is measurable by a set of key performance indicator (KPI)s; receiving a selection to one or more objectives from the presented set of objectives through an input device; outputting a first optimized combination of use cases having the most positive impact to KPIs of the selected set of objectives; and presenting on the display the optimized use cases combination.

This application is a continuation of International Patent Application No. PCT/CN2014/072165, filed Feb. 17, 2014. The International Application claims priority to U.S. Provisional Application No. 61/765,733, filed on Feb. 17, 2013, both of which are hereby incorporated by reference in their entireties.

### TECHNICAL FIELD

The present application relates to technology of communication network management, and more particularly to a method of obtaining optimized use case for communication network.

### BACKGROUND

Communication network management technology is advancing rapidly. For example, as an important branch of the communication network management, modern traffic management technology in the mobile internet market provides mobile operators with more and more capabilities to deploy ever more complex offers and traffic management policies to their customers. Previously in the mobile industry, the business model for monetization was simple: provide customers with a price per minute of voice calls, and/or bundles of minutes per month, within which customers would incur no additional cost beyond their monthly line rental charge. The first data services beyond this simple voice offering came in the form of SMS (Short Message Service). Again, the business model was simple: provide customers with a tariff plan based on the number of SMS included.

However, with the advent of broadband data services, operators are faced with a new challenge, which is how to translate volume of data into real value for customers. This is because one megabyte (MB) of data can carry significantly different volumes of content by type. For example, 1 MB of date may be translated to:
Several days of HTTP (Hypertext Transfer Protocol) browsing
1-10 images
1 minute of SD (Standard Definition) video
10 seconds of HD (High Definition) video
2 minutes of a VoIP (Voice over Internet Protocol) session

Use cases, such as traffic management solutions, provide a rich array of capabilities for mobile network operators to do the following:
Dealing with customers hogging the network
Creating multiple service tiers using Quality of Service (QoS), content limitations and bandwidth priority to realize VIP and low budget services (and anything in between)
Charging based on content type (such as VoIP, streaming video etc)—in order to charge based on value rather than just volume
Managing congested hotspot regions and times of day by deploying different charging and QoS policies as a function of when and where the customer is using their MBB (Mobile Broadband) service
Realizing multi-sided business models by charging 3rd parties for content delivered to customers in exchange for advertising screen-space, or enhanced QoS for customers.

One of the problems for the operators is to decide exactly how to use these capabilities for their specific market situation. Multiple factors (e.g. one use case having both positive and negative impacts, operators having different priorities and operators having limited budget etc.) make this a complicated rather than a simple task.

Existing solutions are piecemeal, non-integrated and human resource-intensive. For a consultant, for example, to help an operator to identify use cases, he/she would most likely have to gather all available use cases, analyze the business objectives of the operator from scratch and manually choose use cases for the operator.

### SUMMARY

By implementing the embodiment provided by this disclosure, the problem that operators currently do not have an solution that can systematically complete a process to identify the optimum capability implementations for their business may be solved.

As a first aspect of the disclosure, a method implemented by a computer for obtaining an optimized combination of use cases for a communication network is provided. The method includes: presenting on a display device a set of objectives, wherein at least one communication network indicator is associated with the set of objectives, and each of the set of objectives is measurable by a set of key performance indicator (KPI)s; receiving a selection to one or more objectives from the presented set of objectives through an input device; outputting a first optimized combination of use cases having the most positive impact to KPIs of the selected set of objectives, according to the selected set of objectives, a set of stored use cases and stored evaluation information; wherein the evaluation information indicates an impact of each of the stored use cases on each of the KPIs of the selected set of objectives; and presenting on the display the first optimized combination of use cases.

As a second aspect of the disclosure, a computer system for obtaining an optimized combination of use cases for a communication network is provided. The computer system includes a memory, at least one processor coupled with the memory, a display, and an input device. The memory is configured to store a computer executable program which includes a front end module and an optimization engine, an objective database, a use case database and an evaluation information database, the display is controlled by the processor for displaying a graphic interaction interface, the input device is configured to obtain an input and provide the input to the processor, and the processor is configured to execute the program. The front end module causes the processor to perform the steps of presenting on the display, a set of objectives from the objective database, wherein the set of objectives is associated to at least one communication network indicator with respect to the communication network, and each of the set of objectives is measurable with a set of key performance indicator (KPI)s; and receiving a selection to one or more objectives from the presented set of objectives through the input device. The optimization engine causes the processor to perform the step of outputting a first optimized combination of use cases from the use case database having the most positive impact to KPIs of the selected set of objectives, according to the selected set of objectives from the front end module, the use case database and the evaluation information database; wherein evaluation information in the evaluation information database indicates an impact of each use case on each of the KPIs of the selected set of objectives. The front end module causes the processor to further perform the step of presenting on the display the first optimized combination of use cases output from the optimization engine.

As a third aspect of the disclosure, a non-transitory computer readable media containing code for obtaining an optimized combination of use cases for a communication network is provided. When the code is executed by a computer, the computer performs the steps of: presenting on a display, a set of objectives from an objective database, wherein the set of objectives is associated to at least one communication network indicator with respect to the communication network, and each of the set of objectives is measurable with a set of key performance indicator (KPI)s; receiving a selection to one or more objectives from the presented set of objectives through an input device; outputting a first optimized combination of use cases from the use case database having the most positive impact to KPIs of the selected set of objectives, according to the selected set of objectives, the use case database and the evaluation information database; wherein evaluation information in the evaluation information database indicates an impact of each use case on each of the KPIs of the selected set of objectives; and presenting on the display the optimized use cases combination.

As a fourth aspect of the disclosure, a data structure stored in a non-transitory computer readable media is provided. The data structure includes: an objective database, wherein objectives in the objective database is associated to at least one communication network indicator with respect to a communication network, and each objectives is measurable with a set of key performance indicator (KPI)s from a KPI database; a use case database, wherein use cases in the use case database indicates an implementation to the communication network; an evaluation information database, wherein evaluation information in the evaluation information database indicates an impact of each use case on each of the KPIs of each objective in the objective database.

Optionally, the objectives includes at least one Tactical Improvement (TI) associated with an operational level indicator of the communication network, controllable by an operator of the communication network, and wherein the set of KPIs used to measure each of the at least one TI comprises a set of Tactical KPIs.

Optionally, the set of objectives includes at least one business objective (BO) associated with a business indicator of the communication network, wherein the set of KPIs used to measure each of the at least one BO comprises a set of Key Value Indicator (KVI)s.

Optionally, the set of objectives includes at least one business objective (BO) associated with a business indicator of the communication network, wherein the set of KPIs used to measure each of the at least one BO comprises a set of Key Value Indicator (KVI)s. The data structure further includes a TI database, wherein TIs in the TI database is associated with an operational level indicator of the communication network, controllable by an operator of the communication network, wherein the KPI database further includes a set of Tactical KPIs used to measure each TI, wherein each BO corresponds to at least one TI, and wherein the evaluation information in the evaluation database specifically indicates an impact of each use case on each of the KVIs of each TI and an impact of each of the Tactical KPIs of each TI on each of the KVIs of each BO.

Optionally, the data structure further includes a value growth point (VGP) database, wherein VGPs in the VGP database corresponds to at least one objective in the objective database.

### BRIEF DESCRIPTION OF THE DRAWINGS

FIG. 1 is a block diagram of a computer system on which a method may be implemented according to an embodiment of the disclosure;

FIG. 2 is a block diagram of a program and a database according to an embodiment of the disclosure;

FIG. 3 is a block diagram of a server-client system according to an embodiment of the disclosure;

FIG. 4 is a block diagram of a cloud computing system according to an embodiment of the disclosure;

FIG. 5 is a flow diagram illustrating a computer implemented method for providing a use case to a communication network according to an embodiment of the disclosure;

FIGS. 6 to 11 show the overall process flow of the application in terms of inputs, activities and outputs according to an embodiment of the disclosure;

FIG. 12 is a block diagram of a user interface for user selecting VGP and Objectives according to an embodiment of the disclosure;

FIG. 13 is a block diagram of a user interface for user selecting TIs according to an embodiment of the disclosure;

FIG. 14 is a block diagram of a user interface for presenting the user a combination of use cases according to an embodiment of the disclosure;

FIG. 15 is a block diagram of a user interface for presenting the user enablers according to an embodiment of the disclosure;

FIG. 16 is a block diagram of an application according to an embodiment of the disclosure;

FIG. 17 is a flow diagram of the application for a use case selection process according to an embodiment of the disclosure;

FIG. 18 is a block diagram of a user interface for user selecting VGP according to an embodiment of the disclosure;

FIG. 19 is a block diagram of a user interface for user selecting Objectives according to an embodiment of the disclosure;

FIG. 20 is a block diagram of a user interface for user selecting Objectives according to an embodiment of the disclosure;

FIG. 21 is a block diagram of a user interface for user selecting TIs according to an embodiment of the disclosure;

FIG. 22 is a table representing impacts of different use cases to different TIs according to an embodiment of the disclosure;

FIG. 23 is a tree diagram representing the choices and priorities of the user according to an embodiment of the disclosure;

FIG. 24 is a value tree view diagram according to an embodiment of the disclosure;

FIG. 25 is a value tree view diagram according to an embodiment of the disclosure;

FIG. 26 is a diagram of a use case description view according to an embodiment of the disclosure;

FIG. 27 is a diagram of a prioritized use cases summary view according to an embodiment of the disclosure;

FIG. 28 is a diagram of an enabler dependency view according to an embodiment of the disclosure;

FIG. 29 is a diagram of an enabler dependency view according to an embodiment of the disclosure;

FIG. 30 is a block diagram of a user interface for user adding enabler constraints according to an embodiment of the disclosure;

FIG. 31 is a diagrammatic view of the libraries and their relationships with each other according to an embodiment of the disclosure;

FIG. 32 is a diagram shows an exemplary relationship between VGPs and Objectives according to an embodiment of the disclosure;

FIG. 33 is a diagram shows an exemplary relationship between business objectives and Tactical Improvements according to an embodiment of the disclosure;

FIG. 34 is a diagram shows an exemplary relationship between Tactical Improvements and use cases according to an embodiment of the disclosure;

FIG. 35 is a diagram shows an exemplary relationship between use cases and Enablers according to an embodiment of the disclosure;

FIGS. 36 and 37 shows a Use Case Template for use cases of Market Offers type according to an embodiment of the disclosure;

FIG. 38 shows a 4CP framework according to an embodiment of the disclosure;

FIG. 39 shows a Use Case Template for use cases of Market Enhancement type according to an embodiment of the disclosure; and

FIG. 40 shows a Use Case Template for use cases of Business Operations Improvement type according to an embodiment of the disclosure.

### DETAILED DESCRIPTION OF ILLUSTRATIVE EMBODIMENTS

In order to make the aforementioned objectives, technical solutions and advantages of the present application more comprehensible, embodiments accompanied with figures are described in detail below.

This disclosure provides details of:
A framework within which this process can be supported (realized in the form of the rules that govern the relationships between Objectives, KPIs, Enablers, use cases, VGPs and TIs).
A library of knowledge, experience and best practice that can be constantly updated and is structured into a framework that supports rapid analysis and comparison.

The value of a solution provided in the following embodiments comes from four things which will be discussed in more detail later.

Database structure—The way in which a relational database has been structured to facilitate the selection of business use cases. It represents a repeatable analysis framework.

Knowledge libraries—The comprehensive knowledgebase that is contained in the libraries of use cases, tactical improvements, objectives, VGPs and components. In this way the solution is also a store of intellectual property representing the collective expertise and experience of the solution provider.

Continuously Updated—The solution provider is able to add, remove, update use cases, tactical improvements, VGPs, etc., over time, as new customer deployments and case studies improve the set of use cases (i.e., one or more use cases) and the understanding of the impact of each use case on the market.

Rapid Insight—Traditionally, the process of linking VGPs with technology solutions requires the user to start from little or no basis point. They must create, assign attributes, and link together, all of the elements from scratch. This solution already contains libraries of pre-defined elements and therefore removes a lot of the pre-work from the typical consulting project.

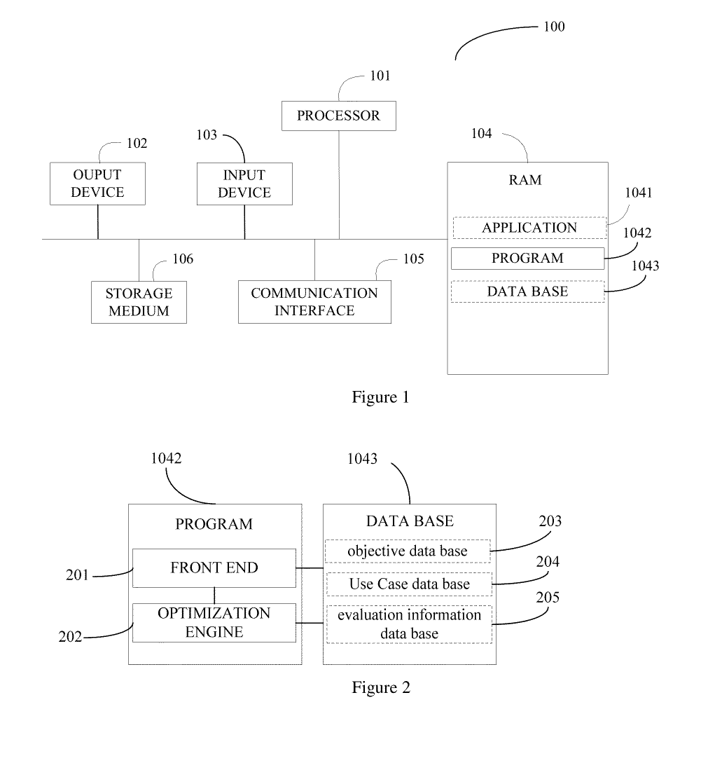

FIG. 1 is a block diagram of a computer system on which the method according to the solution may be implemented. Computer system 100 includes at least one processor 101 coupled with a RAM (Random Access Memory) 104, an output device 102 (e.g. a display device likes a LCD (Liquid Crystal Display), a CRT (Cathode Ray Tube) or a Projector), and an input device 103 (e.g. mouse, keyboard, touch screen, or other input device with a censor detecting the order of the user). The output device 102 is controlled by the processor for displaying a graphic interaction interface to a user. The RAM 104 is configured to store codes for the processor 101 to execute. Optionally, the computer system may include a communication interface 105 for exchanging data with other devices and a storage medium 106 (e.g. ROM (Read-Only Memory), hard disk or flash memory etc.) for storing various codes for the processor 101 to execute in the RAM 104.

The RAM 104 is configured to store a program 1042 and a database 1043 for the computer to perform the method of the solution. Optionally, the RAM 104 is configured to store other applications 1041 such as an operating system application for running the computer, a communication application for communicating with other devices, a client application for accessing a server when working in a server-client scenario or a client application for accessing a data center when working in a cloud computing scenario.

As shown in FIG. 2, the program 1042 includes a front end module 201 and an optimization engine 202. The database 1043 includes an objective database 203, a use case database 204 and an evaluation information database 205. The front end module 201 is configured to cause the processor to perform the steps of: presenting on the output device 102, a set of objectives from the objective database 203 for the user. In this context a set of objectives (or sets of other items) can include one or more objective (or other item). The set of objectives is associated to at least one communication network indicator with respect to the communication network, and each of the set of objectives is measurable with a set of key performance indicator (KPI)s; and receiving a selection to the presented set of objectives from the user through the input device. The optimization engine 202 is configured to cause the processor 101 to perform the step of: outputting a first optimized combination of use cases from the use case database 204 having the most positive impact to KPIs of the selected set of objectives, according to the selected set of objectives from the front end module 201, the use case database 204 and the evaluation information database 205; wherein evaluation information in the evaluation information database 205 indicates an impact of each use case on each of the KPIs of the selected set of objectives. The front end module 201 is further configured to cause the processor 101 to perform the step of: presenting on the output device 102 the optimized use cases combination output from the optimization engine 202, for the user.

For example, the set of objectives may comprise at least one Tactical Improvement (TI) associated with an operational level indicator of the communication network, controllable by an operator of the communication network, and wherein the set of KPIs used to measure each of the at least one TI comprises a set of Tactical KPIs.

Alternatively, the set of objectives may comprise at least one business objective (BO) associated with a business indicator of the communication network, wherein the set of KPIs used to measure each of the at least one BO comprises a set of Key Value Indicator (KVI)s. Once again a set includes one or more.

Optionally, each of the at least one BO corresponds to at least one stored TI. The front end module 201 is further configured to cause the processor 101 to perform the steps of: presenting on the output device 102 TIs corresponding to the selected BOs; and receiving a selection to the presented TIs from the user through the input device 103. The step of outputting the first optimized combination of use cases comprises: outputting the first optimized combination of use cases having the most positive impact to KVIs of the selected BOs, according to the selected BOs and the selected TIs from the front end module, the use case database and the evaluation information database, wherein the evaluation information in the evaluation information database specifically indicates an impact of each use case on each of the KPIs of the selected TIs, and an impact of each of the Tactical KPIs of the selected TIs on each of the KVIs of the selected BOs.

Optionally, the front end module 201 is further configured to cause the processor to perform the steps of: presenting on the output device at least one value growth point (VGP), wherein each of the at least one VGP corresponds to at least one stored objective; and receiving a selection to the presented at least one VGP from the user through the input device. The step of presenting on the output device the set of objectives from the objective database comprises: presenting on the output device objectives corresponding to the selected VGPs for the user.

Optionally, the step of outputting the first optimized combination of use cases comprises: generating a data tree with the KVIs of the selected BOs at the root level and the Tactical KPIs of the selected TIs at the branch level, according to the evaluation information database, wherein each of the KVIs is linked to constituent KPIs by a formula such that the degree of improvement of KVI is a function of degree of improvement of KPI; calculating impacts of combinations of use cases to KVIs of the selected BOs, according to the data tree and the evaluation information database; and outputting the combination of use cases having the most positive impact to KVIs of the selected BOs from the calculated combinations of use cases.

Optionally, the front end module 201 is further configured to cause the processor 101 to perform the step of: receiving ranking to the selected set of objectives from the user through the input device. The step of outputting the first optimized combination of use cases comprises: outputting the first optimized combination of use cases having the most positive impact to KPIs of the selected set of objectives, according to the selected set of objectives from the front end module, the ranking to the selected set of objectives, the use case database and the evaluation information database.

Optionally, the step of outputting the first optimized combination of use cases comprises: calculating impact of each use case to the KPIs of the selected set of objectives according to the evaluation information database; and outputting any use case with a positive impact to the KPIs of the selected set of objectives.

Optionally, the program 1042 further includes an objective filtering module which is not shown in FIG. 2. The objective filtering module is configured to cause the processor to perform the steps of: receiving through the communication interface 105, information of the communication network from an information-gathering device (e.g ISOP) of the communication network; and outputting a set of objectives corresponding to the received information of the communication network. The step of presenting on the output device the set of objectives from the objective database for the user comprises: presenting on the output device the set of objectives output by the objective filtering module for the user.

Optionally, the front end module is further configured to cause the processor to perform the step of: presenting a set of enablers corresponding to the optimized use cases combination, wherein an enabler in the set of the enablers indicates an operational or technical capability for implementing a use case of the optimized use case s combination.

Optionally, the front end module is further configured to cause the processor to perform the steps of: receiving a selection or de-selection to the presented set of enablers from the user through the input device; and highlighting on the output device any objective in the selected set of objectives and/or any use case in the optimized use cases combination influenced by the selection or de-selection of enablers.

Optionally, the optimization engine is further configured to cause the processor to perform the step of: outputting a second optimized combination of use cases having the most positive impact to KPIs of the selected set of objectives, according to the selected set of objectives from the front end module, the use case database, the use case influenced by the selection or de-selection of enablers and the evaluation information database. The front end module is further configured to cause the processor to perform the step of: presenting on the display, by the front end module, the second optimized use cases combination output from the optimization engine, for the user.

The terminologies mentioned above, such as communication network indicator, KPI, use case, TI, Tactical KPIs, BO, KVI, ISOP enablers will be discussed in detail in the following specific embodiment.

Optionally, besides database for elements like objective, use case and evaluation information, there may be databases for other elements, for example: a database for VGP, a database for KPI (Tactical KPI and/or KVI), a database for TI, or a database for the enablers stored in the RAM 104. It can be understood the databases stored in the RAM 104 can be in a form of several separate databases, each including one of the elements mentioned above, in relation with each other, or in a form of a database including at least two of the elements mentioned above.

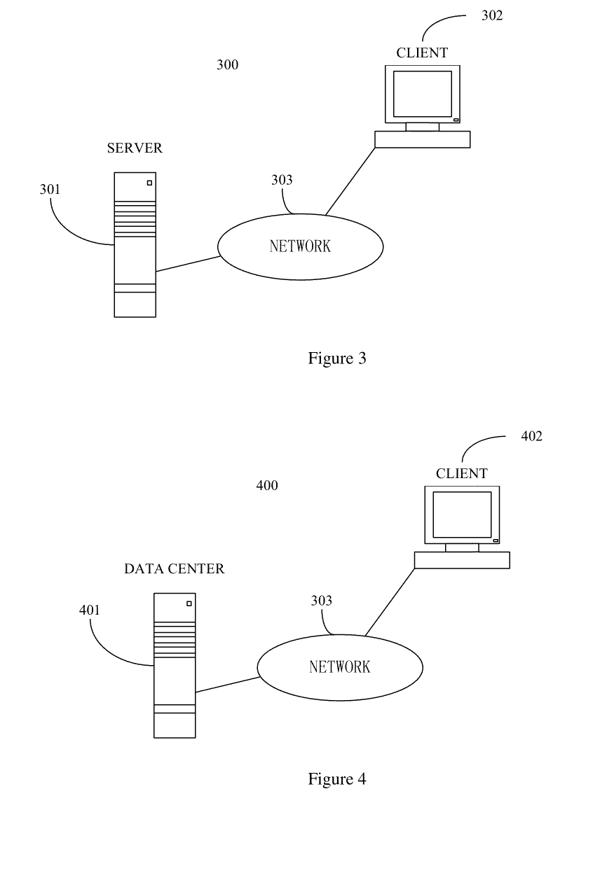

As shown in FIG. 3, this solution can also be implemented in a server-client system 300. The server-client system includes a server 301 in communication with a client 302 through a network 303. Different with the above embodiment, in scenario shown in FIG. 3, the server 301 runs the optimization engine and stores the database. The client 302 runs the front end module and a client application for accessing a server for exchanging data between the front end module and the optimization engine and the database. The server 301 has similar structure as shown in FIG. 1, however, it can be understood that the output device and input device may not be needed in server 301.

As shown in FIG. 4, this solution can also be implemented in a cloud computing system 400. The cloud computing system 400 includes a data center 401 in communication with a client 402 through a network 303. Different with the above embodiment, in scenario shown in FIG. 4, the data center 401 runs the optimization engine and front end module and stores the database. The client 402 runs a client application for accessing the data center 401 receiving information to present a graphic interaction interface for the user, and sending information input by the user to the data center 401. The data center 401 has similar structure as shown in FIG. 1, however, it can be understood that the output device and input device may not be needed in data center 401.

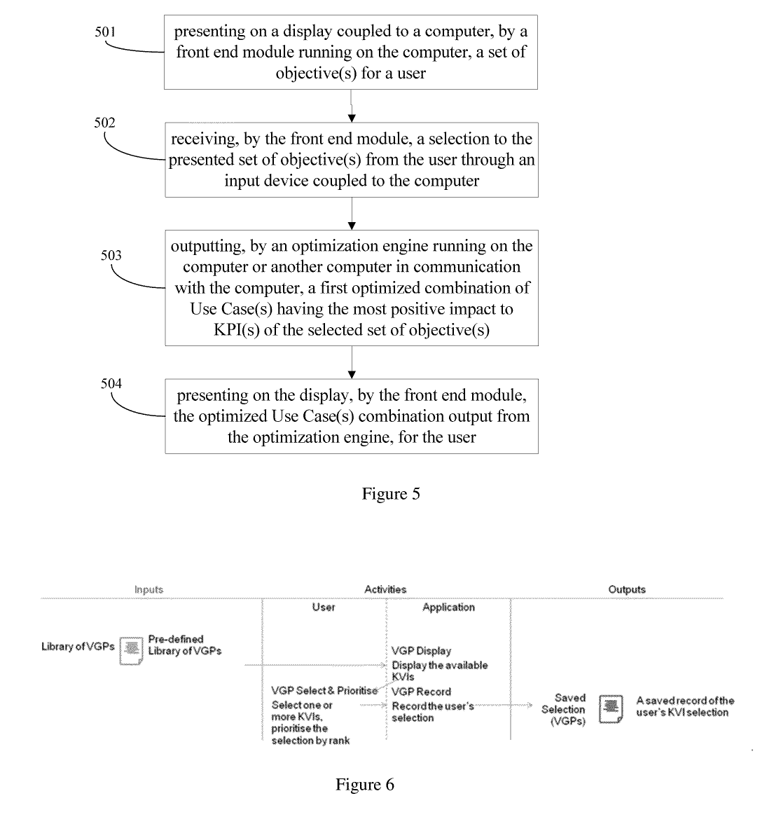

As shown in FIG. 5, it is a flow diagram illustrating the computer implemented method for providing a use case to a communication network.

Block 501: presenting on a display coupled to a computer, by a front end module running on the computer, a set of objectives for a user, wherein the set of objectives is associated to at least one communication network indicator with respect to the communication network, and each of the set of objectives is measurable with a set of key performance indicator (KPI)s;

Block 502: receiving, by the front end module, a selection to the presented set of objectives from the user through an input device coupled to the computer;

Block 503: outputting, by an optimization engine running on the computer or another computer in communication with the computer, a first optimized combination of use cases having the most positive impact to KPIs of the selected set of objectives, according to the selected set of objectives from the front end module, a set of stored use cases and stored evaluation information; wherein the evaluation information indicates an impact of each of the stored use cases on each of the KPIs of the selected set of objectives;

Block 504: presenting on the display, by the front end module, the optimized use cases combination output from the optimization engine, for the user.

A specific software application is disclosed in this embodiment. Table 1 is a description of the application entities which will be used in described the software application.

TABLE 1
a description of the application entities

| Name | Description |
|---|---|
| Value Growth | A VGP is a category of focus for the user (the Operator). A VGP |
| Point (VGP) | ‘contains’ one or more business objectives. For example, ‘Revenue’, |
| | ‘Customer Experience’, ‘Efficiency’, ‘Brand Value’, etc. The application |
| | contains a set of pre-defined VGPs with pre-set links to Objectives. A key |
| | aspect of the application is that VGPs can easily be added, removed, or |
| | updated by the application Administrator, as their understanding and |
| | experience of projects improves. |
| Business | A business objective is a measurable business goal that is relevant to the |
| Objective | user and is typically associated with communication network indicators |
| | like some business pain points of the user's organization (in that the |
| | business objective is to solve the business pain points in some way). An |
| | objective is associated to at least one VGP in that it contributes in a |
| | negative or positive way to business performance in respect of the VGP. |
| | An Objective is defined in business terms, AND in statistical terms (that |
| | is, whether or not the objective is met is measured in terms of KPI |
| | performance). Similarly to VGPs, the application contains a set of pre- |
| | defined business objectives with pre-set links to VGPs and KPIs, which |
| | can be added, removed or updated by an Administrator. |
| | For example: “More add-on purchases” (measured by percentage of total |
| | revenue derived from add-on purchases by end customers) |
| Tactical | A Tactical Improvement is a change in the way the operator behaves at an |
| Improvement | operational level, and is associated with communication network |
| | indicator at an operational level. A Tactical Improvement differs from a |
| | business objective in that it is completely controllable by the Operator, |
| | given the necessary resources, funding and capabilities. A Tactical |
| | Improvement is defined in business terms and statistical terms, through |
| | KPIs, (as is the case for business objectives). A Tactical Improvement is |
| | associated with at least one business objective in that it contributes in a |
| | positive or negative way to the measurable performance in respect of the |
| | business objective. Similarly to business objectives and VGPs, the |
| | application contains a set of pre-defined Tactical Improvements that can |
| | be added, removed or updated by an Administrator. |
| | For example: “Wider range of add-on services” (measured by the volume |
| | of add-on services available on the market) |
| Use Case | A use case is a specific implementation that can be carried out by the |
| | user's organization. A use case can be realized by a specific combination |
| | of marketing, technical and organizational implementations. A use case is |
| | always associated with at least one Tactical Improvement. Similarly to |
| | Tactical improvements, business objectives and VGPs, a use case can be |
| | added, removed, or updated by the Administrator. A use case consists of a |
| | set of characteristics that constitute a product or capability (business or |
| | technical). Beyond the use case, the only additional decisions required of |
| | the user concern configuration items such as the specific price, quality of |
| | service setting, customer segment criteria, etc. This patent application |
| | contains details of a common use case Framework. |
| | For example: “Family Sharing - one lead subscriber may share their |
| | monthly data quota with other subscribers who must be related to the |
| | lead subscriber” |
| Enabler | An enabler is an operational or technical capability that is required to |
| | implement a use case. An Enabler is always associated to at least one use |
| | case in a binary relationship (it either is, or is not, required for the use |
| | case). The Administrator can add, remove, or update Enablers although |
| | this is less common. The Enabler can be defined in any format, not |
| | within any particular framework (technical enablers are defined by their |
| | specification documents for example, while operational enablers are |
| | defined by service requirements, PowerPoint documents, etc). There are |
| | no KPIs associated with Enablers. |
| Key | A Tactical Improvement is associated with one or more KPIs (Tactical |
| Performance | KPIs). The application user would use the associated KPIs to measure |
| Indicator (KPI) | whether or not the Tactical Improvement is being achieved. |
| | Key performance indicator is a general business term. For this |
| | application, the meaning is similar to the generally accepted definition: A |
| | metric indicator describing the performance of a business in a specific |
| | business area, which is derived from data calculation. In this application, |
| | because we also use KVIs, we restrict KPIs to only those metrics that |
| | would be of interest to the operational level of business management |
| | (middle management). |
| Key Value | A business objective is associated with one or more KVIs. The |
| Indicator (KVI) | application user would use the associated KVIs to measure whether or |
| | not the business objective is being met. |
| | A KVI is a type of KPI, which is of key interest to the board level of a |
| | company. KVIs may for example appear on the company's annual report. |
| | A KVI is more likely to describe the general health of the company, |
| | rather than the performance of a business department (which itself might |
| | not actually mean that the overall business is performing well in the eyes |
| | of the shareholders). |

In broad terms, the application may complete part or all of the following tasks:
1. The user (for example a consultant working on behalf of an operator) inputs the business priorities that the operator wants to focus on (termed as ‘Value Growth Points’)
   a. The application presents the user with a list of Value Growth Points (VGPs)
   b. The user chooses the VGPs that apply
   c. The user prioritizes the VGPs by ranking in order of importance
2. The user inputs the business objectives of the operator:
   a. The application presents the user with a list of objectives
   b. The user chooses the objectives that apply
   c. The user prioritizes the objectives by ranking in order of importance
3. The application presents the user with a set of KPIs for each objective, against which the success of the operator to achieve the objective can be measured.
4. The application presents the user with a set of Tactical Improvements (the improvements required to deliver KPI performance).
   a. The user selects the tactical improvements that apply,
   b. The user ranks the tactical improvements according to importance.
5. The application presents the user with a list of recommended use cases:
   a. For each use case, there is a profile of the potential KPI improvement that can be realized.
   b. The use cases are ranked automatically by the application according to the level of impact on the prioritized business objectives selected by the user.
6. The application presents the user with the traffic management capabilities (which are termed ‘enablers’) required to deliver the use cases.
7. The user chooses all, or a subset of these enablers (depending on budget and current capabilities).
8. The application updates the list of recommended use cases based on the technological constraints of the user's enabler selection (if applicable).

The application may include the following components to deliver the output to the user:
1. Libraries of use cases, business KPIs, objectives, tactical improvements and Value Growth Points (VGPs). Library items can be easy to add, remove, and update by the end user.
2. Relational database that details the association between the libraries (for example, the business objectives associated with a VGP and the KPIs associated with an objective)
3. Optimization Engine that maximizes the potential benefit to the operator based on their prioritized selection.
4. Presentation GUI that guides the user through the selection process outlined above.

FIGS. 6 to 11 show the overall process flow of the application in terms of inputs, activities and outputs.

As shown in FIG. 6, the user (for example a consultant working on behalf of an operator) inputs the business priorities that the operator wants to focus on (termed as ‘Value Growth Points’) by selection. Optionally, the user may prioritize the selected Value Growth Points.

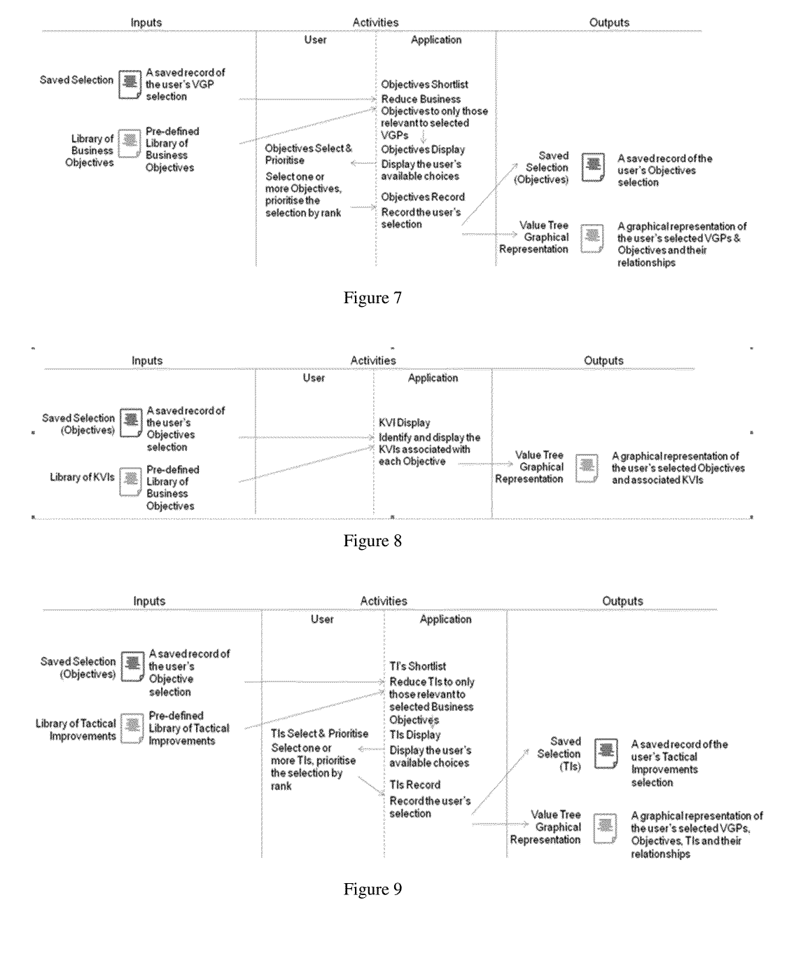

As shown in FIG. 7, the user inputs the business objectives of the operator by selection. Optionally, the user may prioritize the selected business objectives.

As shown in FIG. 8, the application presents the user with a set of KVIs for each objective, against which the success of the operator to achieve the objective can be measured.

As shown in FIG. 9, the application presents the user with a set of Tactical Improvements (the improvements required to deliver KPI performance). The user inputs a selection of the Tactical Improvements. Optionally, the user may prioritize the selected Tactical Improvements.

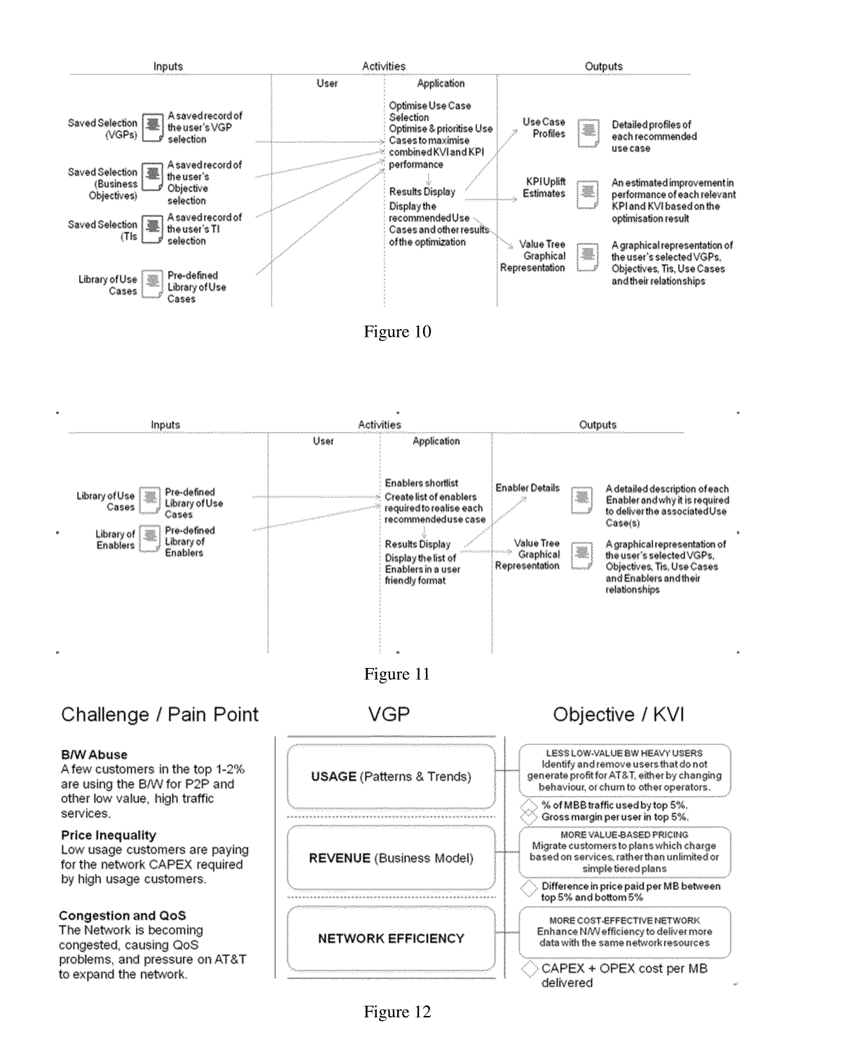

As shown in FIG. 10, the application presents the user with a list of recommended use cases.

As shown in FIG. 11, the application presents the user with the enablers required to deliver the use cases.

A methodology example is provided here on how the methodology supported by this application can be used to help operators identify relevant use cases.

The Operator would first have to consider what its VGPs are, and then select business objectives within the VGP areas. From a consulting perspective, this means the Operator should clearly assess/decide on its pain points. KVIs appear here by association to business objectives (whether or not a business objective is being achieved will be measured by performance of the associated KVIs, where the KVIs give an indication of the overall performance of the business).

The application proposed may firstly analyze the customer's network for signatures of pain points. This may be done by using a server system in the communication network (e.g. an Internetized Smart Operation Platform (ISOP) component). Based on this the application will recommend to the user a set of VGPs and corresponding Objectives.

As an embodiment, the server system in the communication network may collecting information from operator's network (the CRM, CBS, probe, DPI, DWN, etc.), then analysis to obtain the set of VGPs and corresponding Objectives.

Alternatively the user may manually select the VGPs and Objectives that they consider relevant for their specific business scenario.

As shown in FIG. 12, a user interface for user selecting VGP and Objectives is provided. The green boxes represent Objectives, and the green diamonds represent the KVIs that are associated to these Objectives (where the KVIs are automatically identified by the application through the pre-defined relationships specified in the KVI library). The gray boxes represent VGPs. The Challenges/Pain Points are background information items that lead the user, in this example, to make the selections evident from the VGPs and Objectives.

The operator would then select the Tactical Improvements it needs to implement in order to have a positive influence on its objectives. The application may partially automate this process through a pre-populated Library of Tactical Improvements, with pre-defined relationships to objectives. The Application would show the user any TIs that have a positive impact on the selected objectives. The application would also show the corresponding KPIs that are used to measure the success of the operator in realizing its Tactical Improvements. The application would also show the strength of the association on a scale of −10 to 10, which may be also pre-set in related database.

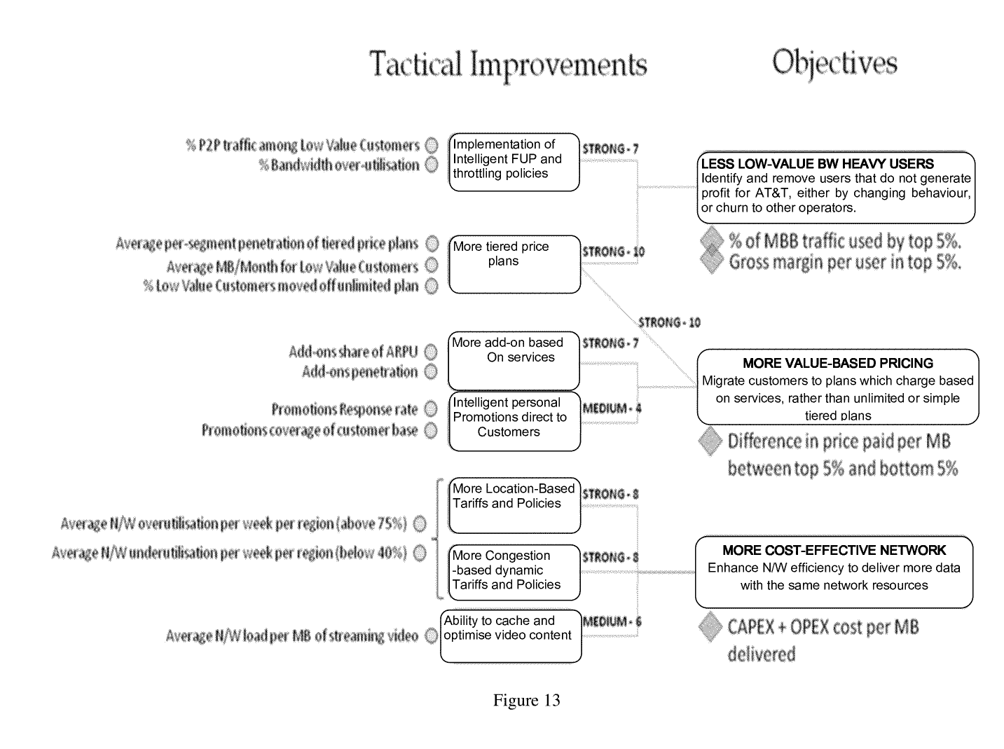

As shown in FIG. 13, a user interface for user selecting TIs are provided. The green boxes represent objectives, and the green diamonds represent the KVIs that are associated to these objectives (where the KVIs are automatically identified by the application through the pre-defined relationships specified in the KVI library). The yellow boxes represent Tactical Improvements, and the green circles represent KPIs (where the KPIs are automatically identified by the application through the pre-defined relationships specified in the KPI library). As is described later in this document, the relationships between TIs and Objectives are scalar, ranging from 0 (no relevance) to 10 (strong relevance) in the positive or negative directions. Effectively, the user only has to select Objectives and TIs, everything else may be pre-specified by the Administrator and stored in the various libraries.

The optimization step for providing the user a combination of use cases can be fully automated by the application. The application would calculate, based on the selections and prioritizations specified by the user, the combination of use cases that would maximize the improvement for the Operator to their KPI performance levels. There are a number of optimization techniques available for this. This disclosure does not seek to protect any specific optimization technique (linear and quadratic optimization is a mainstream field of academic study with a host of applications that can support such a procedure).

As a general overview of the calculation process: the application would complete the following calculation steps:
a. Create a KPI tree with KVIs at the root and KPIs at the branch level (based on KVIs and KPIs associated with the selected Objectives and TIs)
b. Link the KVIs to constituent KPIs by a formula such that the degree of improvement of KVI performance is a function of degree of improvement of KPI performance
c. Populate the formula for each KVI with the scores (from −10 to 10) which are pre-populated for the relevant Objective and TI relationships
d. Define an optimization problem/goal which is to maximize the combined KVI improvement, adjusted for the priorities set by the user (i.e. the improvement of higher priority KVIs has a higher influence on the combined score than improvement of lower priority KVIs, and the same applies to KPIs)
e. Identify the combination of use cases that results in the maximum possible combined improvement based on the optimization problem/goal.

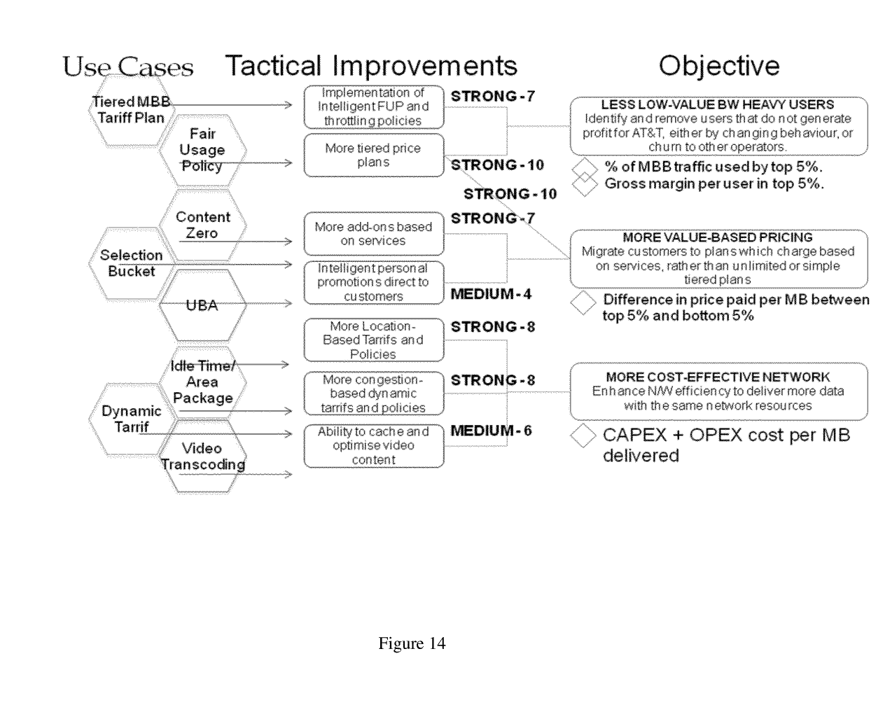

As shown in FIG. 14, a user interface for presenting the user a combination of use cases is provided. Each of the use cases is defined within a framework of form fields, which is described later in this disclosure.

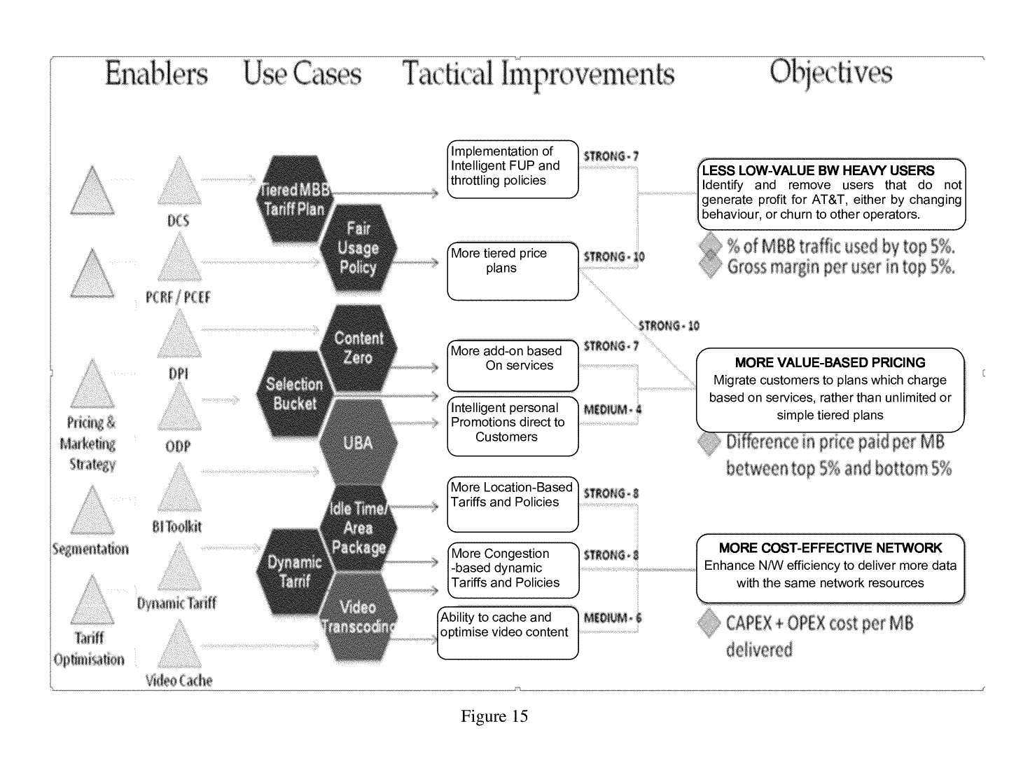

The Application would then display the set of enablers that is needed to realize each of the recommended use cases. This can be an automated step. The application does this by drawing on the database table for use cases which contains the use case details, and the associations between use cases and Tactical Improvements. As shown in FIG. 15, a user interface for presenting the user enablers is provided.

In the embodiment, the application can be realized by several modules. For example, the application may include several libraries for storing the VGP, Objectives, KPI, Use case, Enablers and relationship among them, optimization engine for generating the list of priority use cases and front end for presenting the user a user interface.

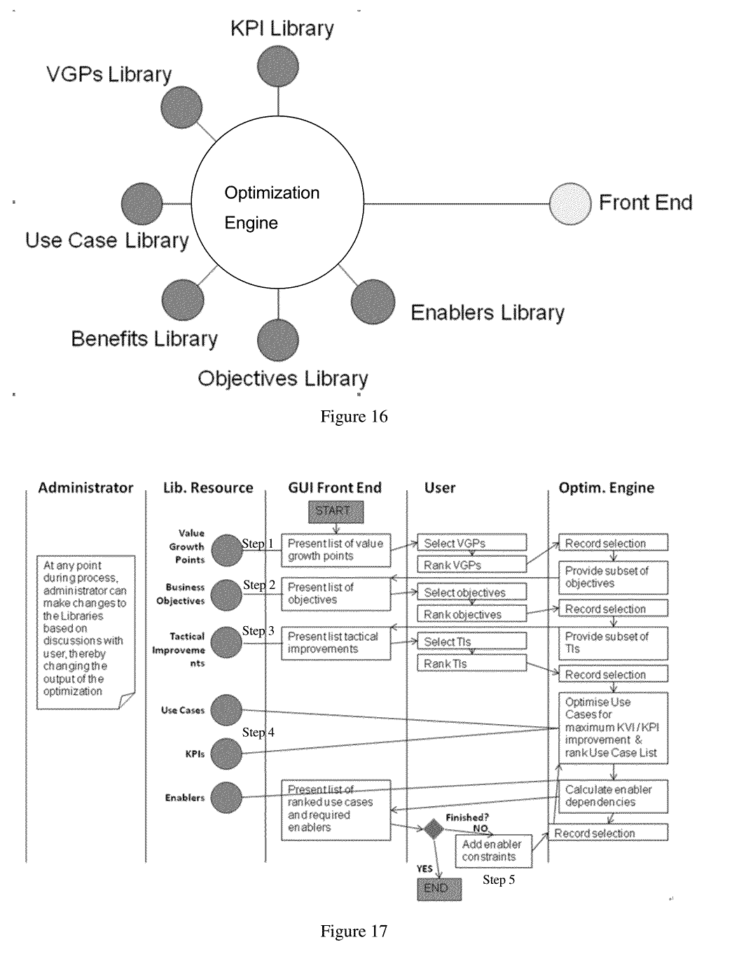

As shown in FIG. 16, the libraries may comprise VGPs library, KPI library, Use Case Library, Benefits Library, Objectives Library, Enablers Library. Each of the libraries can be continuously updated by the application provider. The contents of each library represent the experience, knowledge, and intellectual property of the application provider. The libraries together comprise a relational database, which stores the relationships between the different entities, and the tables detailing the entities themselves.

The front end is a Graphical User Interface (GUI) that leads the user through the selection process, from selecting VGPs to selecting use cases.

The optimization engine generates the list of priority use cases by maximizing the combination of KPI improvements as prioritized by the user.

In the following pages each of these elements will be described in more detail.

As shown in FIG. 17, a flow diagram of the application for a use case selection process is provided.

The ranking step and VGP selection step in the process may be optional and can be non-essential to the optimization result, and are in place to enhance and improve the user's selection process. Ranking of VGPs, Objectives and TIs as part of the selection process allows the optimization to be more accurate by prioritizing those VGPs, Objectives and use cases that are of highest importance to the user. However, if the user does not rank these items, the optimization engine can work on the assumption that each selection is equally important. The VGP selection allows the application to filter out non-relevant objectives and TIs. It does not impact on the optimization result other than to add an additional prioritization layer through the ranking activity. If this were to be excluded from the workflow, the user would be presented with all possible Objectives instead of only those relevant to the selected VGPs.

As shown in FIG. 17, after the application starts, in step 1 of the process, the application may present a list of value Growth Points for the user to select and optionally to rank, and then record the user's input. In step 1, the user is choosing the high level ‘scope’ of the analysis at this step. Value Growth Points include general categories of strategic focus, for example: Efficiency Improvement, Revenue Growth and Brand value improvement. The user can select one, all, or a subset of the available VGPs. If they select more than one, they may rank the selection in order of priority. This is because it is possible that one VGP can be improved but at the expense of another, so the objectives, tactical improvements and use cases later will be optimized for the highest priority VGPs first. The Optimization Engine may not do any calculation at this point. It may only take the user's selections and rankings from the Front end module and records them for later calculations.

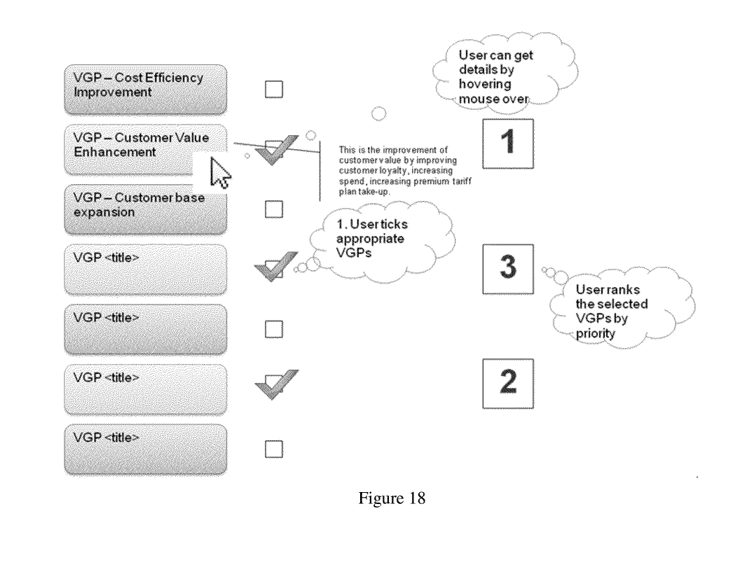

As shown in FIG. 18, in step 1, a block diagram of a user interface rendered by the Front end module for user selecting VGP is provided.

The Front end module may: call the VGP library, arrange the VGPs into a readable structure which allows the user to scroll up and down, show the user a description of the VGP if they hover over the VGP title, show the user tick boxes and prioritization fields, error-check the user's input (for example, cannot rank two VGPs the same, cannot have zero VGPs ticked, etc.).

As shown in FIG. 17, in step 2 of the process, based on the user's selection of VGPs in the previous stage, the application presents the list of applicable Objectives. In this step, the user is considering which of the potential business objectives is aligned to their overall strategy, and selecting the ones that they want to explore further. They may select and rank the objectives exactly as they did in the previous stage. An Objective is a high level, CxO facing business objective that is associated with one or more KPIs (which are called KVIs when refers to the business objectives). The optimization engine is involved at this stage by remembering the user's selection of VGPs. It may only present the Objectives that have a positive relationship with the selected KVIs (It is possible for one objective to contribute to more than one VGP, as illustrated below).

As an example, Objective could include:
Reduce Capacity over-utilization and under-utilization
   Measured by the KVI: “Percentage of cells utilized above 95%+percentage of cells utilized below 40%”
Increase revenue from add-on services
   Measured by the KVI: “add-ons share of ARPU”
Increase smartphone device penetration
   Measured by the KVI “% change in smartphone penetration”

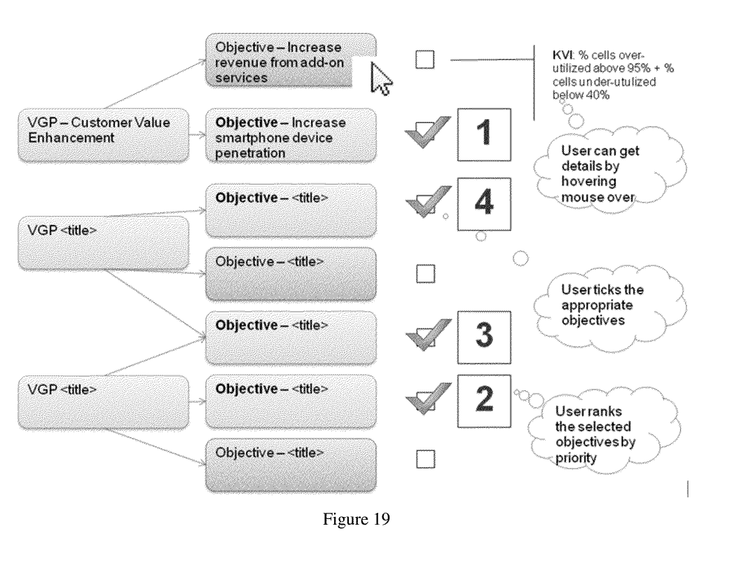

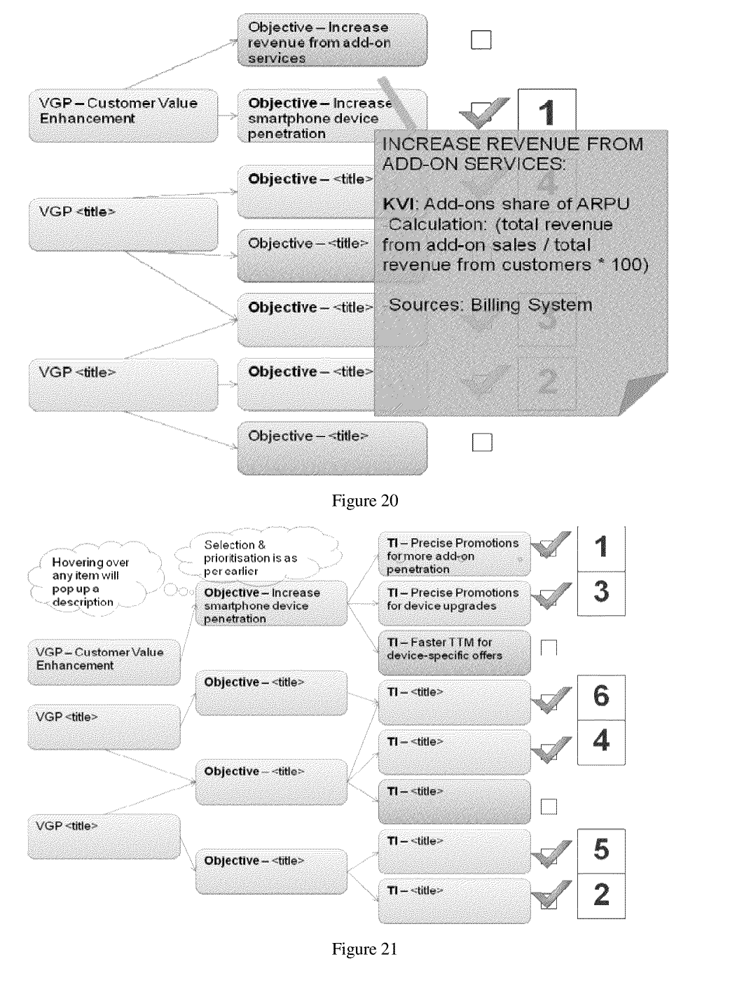

As shown in FIG. 19, in step 2, a block diagram of a user interface rendered by the Front end module for user selecting Objectives is provided. The front end module shows the user the progress of the selection process by showing the selections from the previous stages. As shown in FIG. 20, by clicking on an objective in the GUI window presented by the front end module, the user can see the details of the KVIs that can be used to measure whether or not the objective is being met.

In step 2 of the process, the Objectives library is called by the optimization engine. The optimization engine may check the selection of the previous stage, create a shortlist of the applicable candidate objectives and sends the content to the front end module. The Front End front end module may arrange the VGPs and objectives into a tree structure, remove the VGPs that were not selected in the previous stage, and draw lines between the VGPs and objectives that have a relationship. The Front End front end module may further show the user a description of the VGP or Objective if they hover over the VGP title or Objective title, show the user tick boxes and prioritization fields, and error-check the user's input (e.g. cannot rank two objectives the same, cannot have zero objectives ticked for any single VGP, etc.). After user's selection and optional ranking, the Optimization Engine takes the user's selections and rankings from the front end module and records them for later.

As shown in FIG. 17, in step 3 of the process, based on the user's selection of VGPs and Objectives in the previous stages, the application presents the list of applicable Tactical Improvements. In this step, the user is considering which of the potential Tactical Improvements their business organization is capable of supporting and/or which of them they want to be able to support in future. In many cases, to deliver a tactical improvement requires some extent of organizational change (for example, adding new responsibilities, business processes, training courses, etc.), so the organization has to carefully consider the change initiatives they must realize alongside any technology deployments (the ‘Enablers’ which will be discussed later). This is why the realistic user might remove some of the TIs from the list (not because of any problems with alignment to their overall business strategy which was covered in the last 2 stages).

Below is a set of example tactical improvements and KPIs:
Reduced congestion by incentivizing customers to consume less data in hotspots
   Measured by the KPI: “Percentage of customers responding to usage behavior incentives”
More Add-On penetration through precise promotions and relevant offers
   Measured by the KPI: “change in percentage of customers purchasing add-ons”
   Measured by the KPI: “number of successful Add-on offers on Market”
Faster TTM for Add-on offers
   Measured by the KPI: “% reduction in average TTM for add-ons”

The optimization engine is involved at this stage by remembering the user's selection of objectives from the previous step. It may only present the Tactical Improvements that have a positive relationship to the selected Objectives (It is possible for one tactical improvement to contribute to more than one Objective, as illustrated below). It may perform the actual calculations to optimize the selected output once the user has made all the selections.

As shown in FIG. 21, in step 3, a block diagram of a user interface rendered by the Front end module for user selecting TIs is provided. Essentially there is very little difference technically between this and the previous step (objective selection), the user is basically selecting and ranking from a choice of relevant options. The front end module shows the user the progress of the selection process by showing the selections from the previous stages. As in the previous step, the user can click on an objective or TI to view the KVIs and KPIs used to measure whether or not the Objective/TI ids being achieved. The user can also see a description of the objective, VGP or TI by hovering the mouse pointer over the item (as in the previous steps).

In step 3 of the process, the TIs Library is called by the Optimization Engine. The optimization engine may check the selection of the objectives in the previous stage, create a shortlist of the applicable candidates and send these to the front end module. The front end module may:
Shows the user the selections from the previous stages arranged in a user-friendly way, with lines connecting the elements with positive relationships.
Shows the list of possible TIs for the user to choose from.
Shows the user a description of any item they hover the mouse over.
Shows the tick-boxes and prioritization fields.
Conducts error-checking on the user's input as in earlier stages.

The Optimization Engine may take the user's selections and rankings of the TIs from the GUI and records them for later.

The user's selection may be prioritized for two reasons. Takes the ranking of the TIs for example. If the relationship between a use case and a TI was always positive, then it would be a simple case of just choosing all of the use cases that have any impact on all of the TIs. Or, if the relationship between a use case and a TI was exclusive (that is, the same use case has no impact on any other TIs) then it would be a simple case of just choosing all of the use cases that have a positive impact on the TI in question. But unfortunately this is not the case. The following characteristics are true of use cases:
One use case can have a positive impact on one TI but a negative impact on another (for example, “Facebook Zero” has a positive impact on customer base, but a negative impact on customer value because it attracts new customers but drives down the effective cost per MB to customers.
   Therefore, the optimization engine will in some cases have to choose between multiple combinations of use cases with no clear winner in terms of net impact on TIs, other than by the priorities selected by the user.

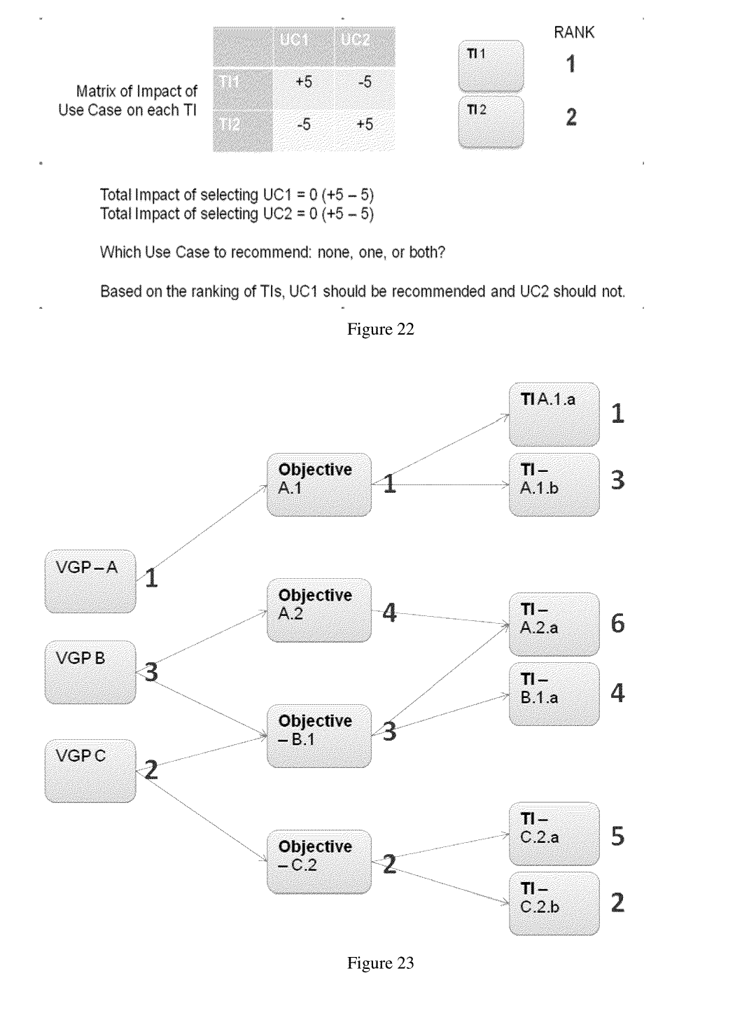

Take for example the scenario shown in FIG. 22, use case UC1 has impact +5 to TI1, and impact −5 to TI2. Use case UC2 has impact −5 to TI1, and impact +5 o TI2. Without considering the ranks of TI1 and TI2, it is hard to choose a specific use case, for the total impact of the UC1 or UC2 to the TIs are 0. If the ranks of TB and TI2 are provided, e.g. TI1 ranks the first and TI2 ranks the second, then the UC1 should be chosen.

The TI selection from the user may be the end of the user's main scoping input activities. For the user, later stages are to refine the selection and/or add enabler constraints. The next phase of the process after the user has finished input of choices and priorities is to calculate the optimum list of use cases. This is primarily the responsibility of the Optimization Engine, as shown in FIG. 17, step 4 of the process.

The Optimization Engine has recorded all of the choices and priorities of the user, as represented in FIG. 23.

In practice the optimization algorithm can be taken from a large selection of established mathematical techniques, for which there are free and premium products already commercially available, such as: Linear Programming Techniques and MS Excel Solver add-in.

The optimization engine is precisely that, an optimization engine, not a simple selection engine. For example, any use case has a set of dependencies/enablers. Therefore, if the user has chosen to limit the range of enablers they want to consider, then the optimization engine may remove any use cases that are not feasible as a result from the calculation.

The optimization engine at this stage is assessing every use case in the use case library, against each of the selected TIs, then may:
Calculates the net impact of each use case on each TI, and then translates this to KPI performance improvement.
Removes any use cases with a negative net impact (even after prioritization taken into account)
Ranks the use cases with a positive impact according to the net impact on TIs, adjusted for the priorities set by the user.
   This procedure is also described in more technical terms in previous paragraphs.

In step 4, the front end module may show the user the progress of the selection process by showing the selections from the previous stages. There are a number of views available to the user here.

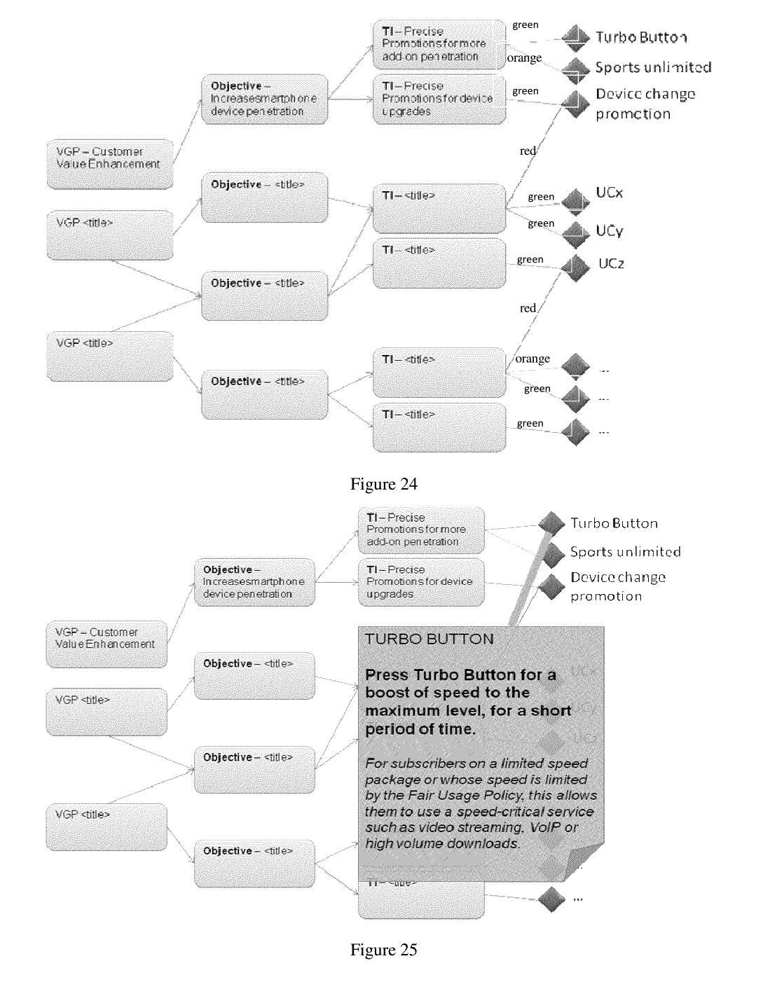

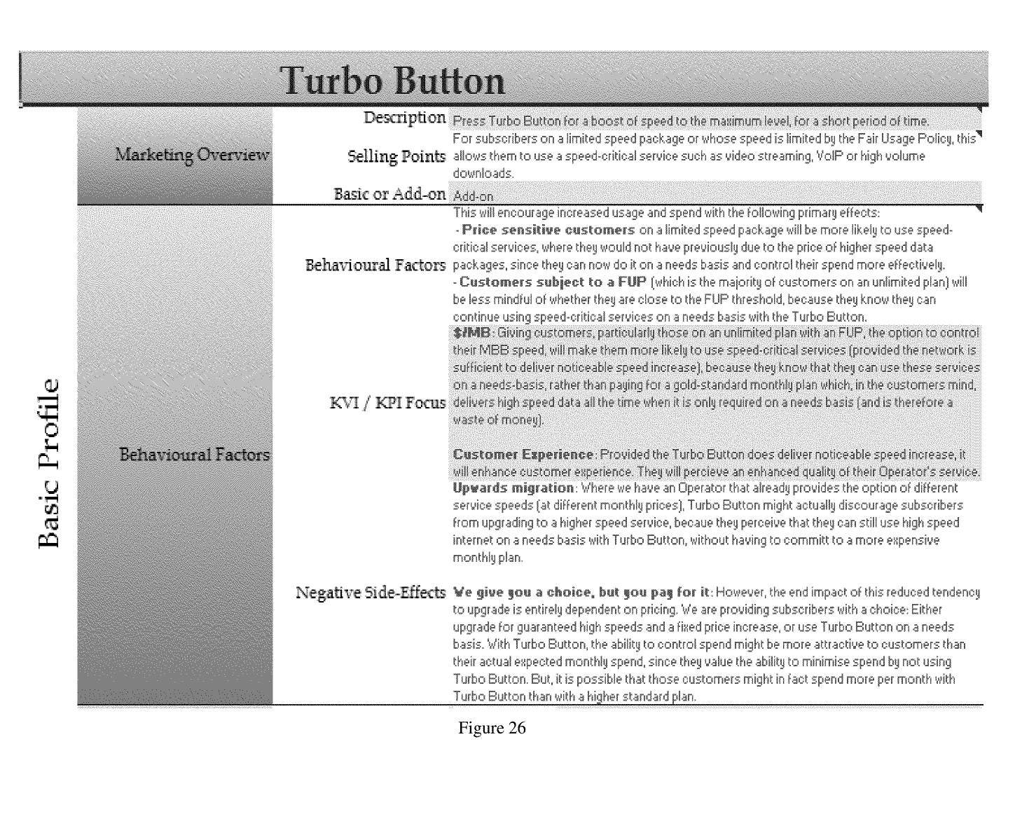

As shown in FIG. 24, a Value Tree View is provided here. The green lines indicate an overall positive effect of the use case on the TI. The orange lines indicate an overall neutral or negligible effect of the use case on the TI. The red lines indicate an overall negative effect of the use case on the TI. As shown in FIG. 25, the user can hover over a use case to see a summary-level description, or click on it to enter the use case description view (as in the 4CP framework which will be shown later in this disclosure) shown in FIG. 26.

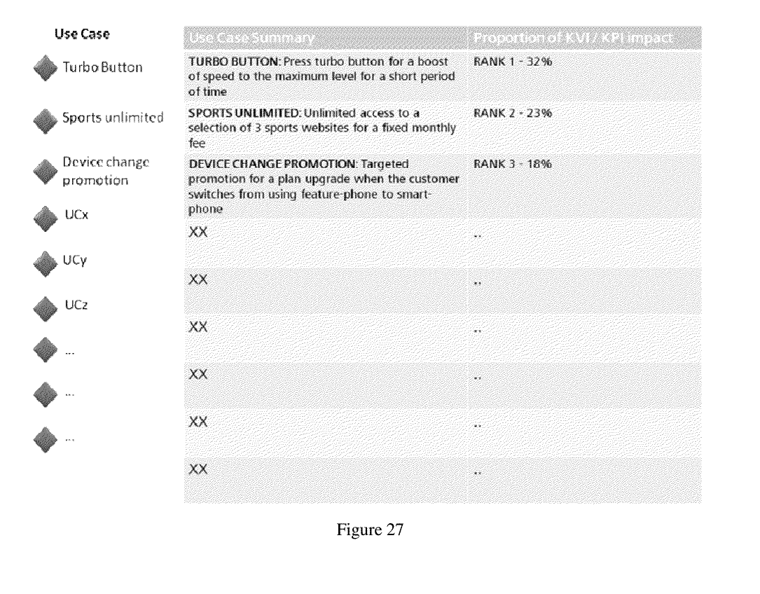

As shown in FIG. 27, a prioritized use cases summary view is provided here.

The user can select to view the use cases ranked by overall impact, as optimized by the application based on the priorities and selections of the user.

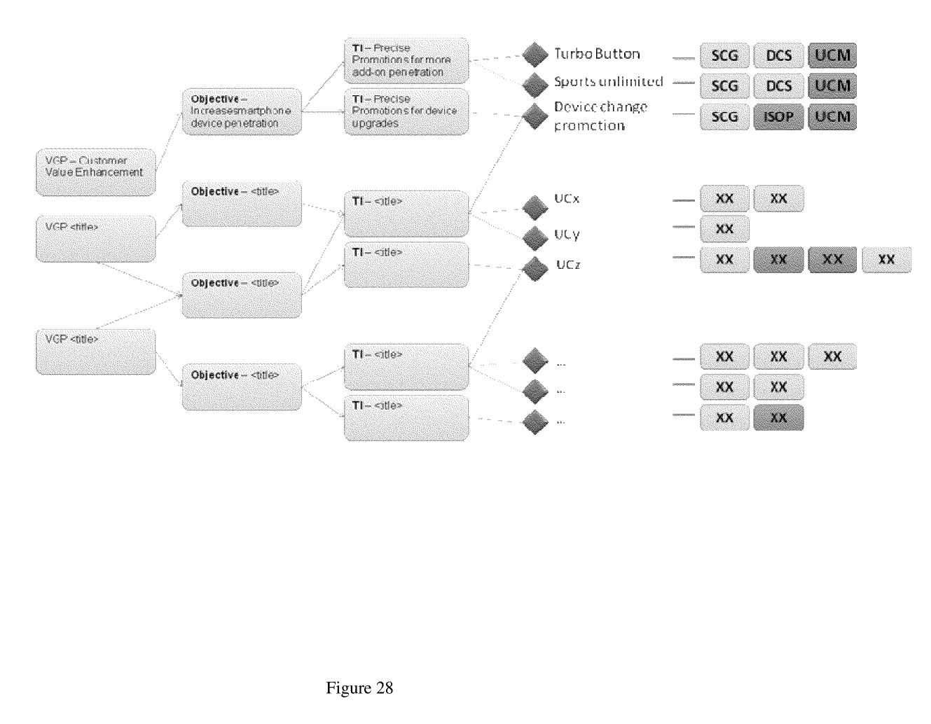

As shown in FIG. 28, an enabler dependency view is provided here. The User can view the use cases along with the enablers necessary to make them possible.

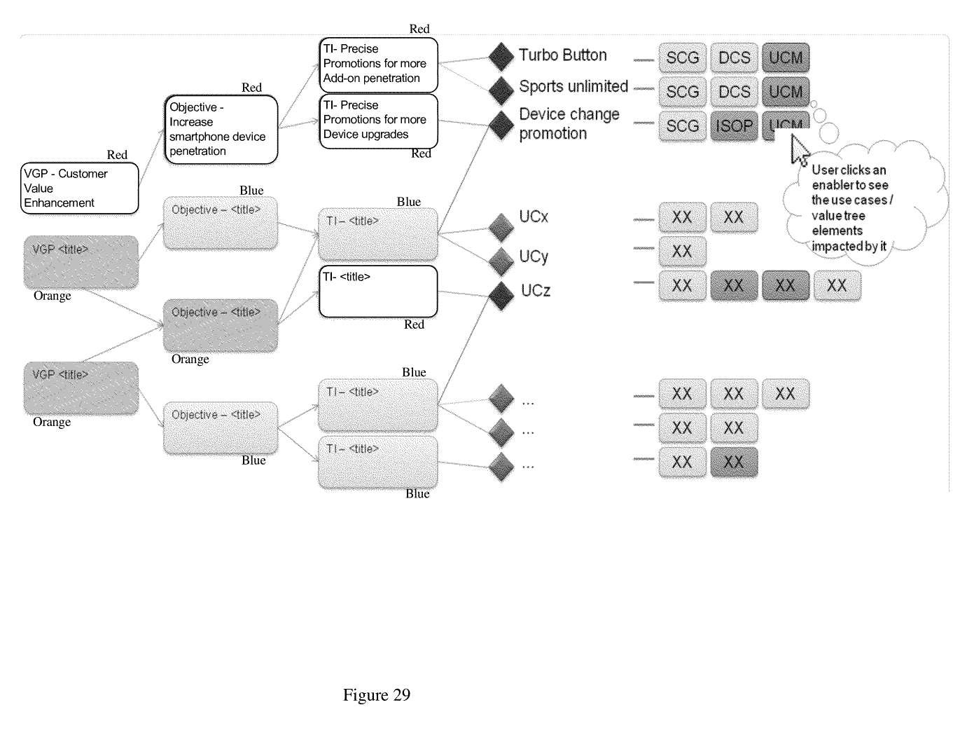

As shown in FIG. 29, the user can click on one of the enablers and see the use cases that require it, and the TIs, Objectives and VGPs that are at least partially dependent on it. The color-coding for this diagram is as follows:
ORANGE—Orange boxes indicate that the user's ability to deliver improvement to the VGP, Objective or TI is negatively impacted by the removal of some Enablers by the user.
BLUE—Blue boxes indicate that the TI, Objective or VGP is not impacted by the user's removal of some Enablers.
RED—Red boxes indicate that the TI, Objective or use case cannot be realized as a result of the removal of some Enablers by the user. Similarly red use cases indicate that the use case cannot be realized as a result of the removal of some Enablers by the user.

In step 4 of the process, The use case library is called by the optimization engine. The optimization engine:
Calculates the optimum selection of use cases based on the selections and priorities chosen by the user. It can do this because:
   The use case library contains an impact score for each TI, for each use case, ranging from negative to positive.
   The user has ranked the TIs in order of importance in the previous stage
Identifies the Enablers necessary to realize each use case.
   The Front End module:
Shows the user the various views that give the relationships between ultimately VGPs and use cases, the rankings of the use cases, the detail pages etc. shown in FIGS. 24 to 29.

As shown in step 5 of FIG. 17, the user can add enabler constraints to the output use cases. One output from the previous stage (optimizing and prioritization of use cases) is a list of the enabler components needed to realize each use case. An important consideration for choosing use cases is to understand the scale of investment and change required to realize each use case. On the other hand, an important consideration for choosing technology investments is to understand the extent of use case capability that the technology products enable (the market potential of each product). The application described in this document allows the user to see both of these things (the market potential of technology products and the high level scale of investment and change associated with each use case) at a high level.

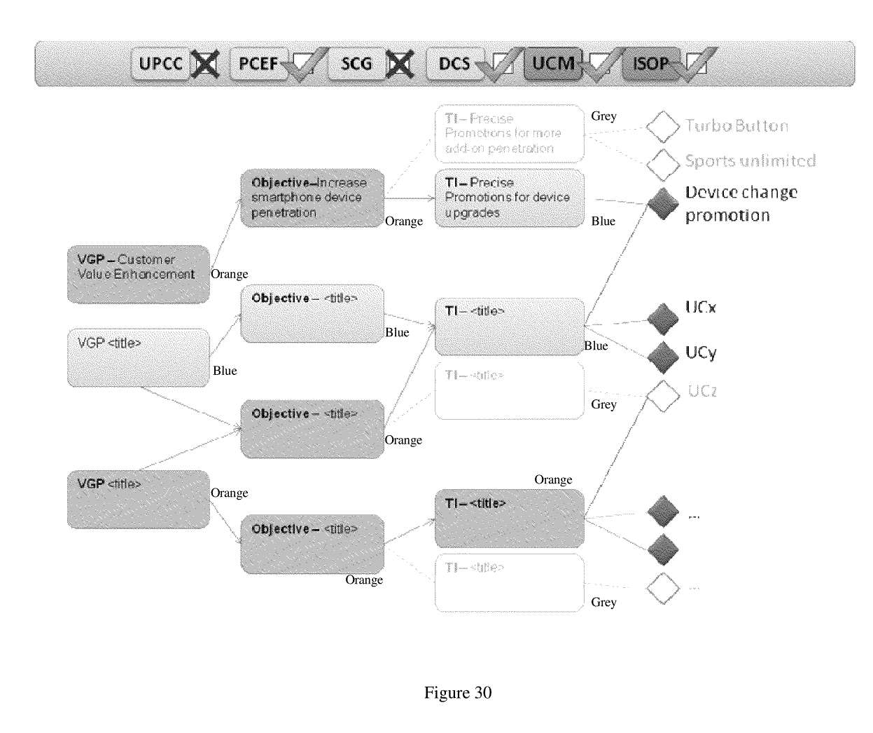

As shown in FIG. 30, the user is presented with a list of the technology enablers needed to realize the use cases identified from the previous steps. They can select or de-select items and see graphically the effect this has on the ability to meet objectives and achieve Tactical Improvements. The color-coding in FIG. 30 is as follows:
ORANGE—Orange boxes indicate that the user's ability to deliver improvement to the VGP, Objective or TI is negatively impacted by the removal of some Enablers by the user.
BLUE—Blue boxes indicate that the TI, Objective or VGP is not impacted by the user's removal of some Enablers.
GREY—Grey boxes indicate that the TI cannot be realized as a result of the removal of some Enablers by the user. Similarly Grey use cases indicate that the use case cannot be realized as a result of the removal of some Enablers by the user.

In the step 5, the use case Library is called by the Optimization Engine. The optimization engine:
Adds the Enabler constraints to the optimization problem/goal, such that:
   No use case may be dependent on any of the excluded Enablers
Identifies the use cases that are not feasible due to Enabler exclusions but would have been recommended had there not been any exclusions in place
Passes these on to the GUI
Calculates the difference in KPI and KVI performance vs. having all recommended use cases
   The front end module:
Displays all potential use cases (as in the previous step)
Color-codes the use cases in order to show at a glance those use cases that are no longer feasible with the Enabler constraints in place.

As a general note, the user may at any time during the process choose to go back and update earlier choices.

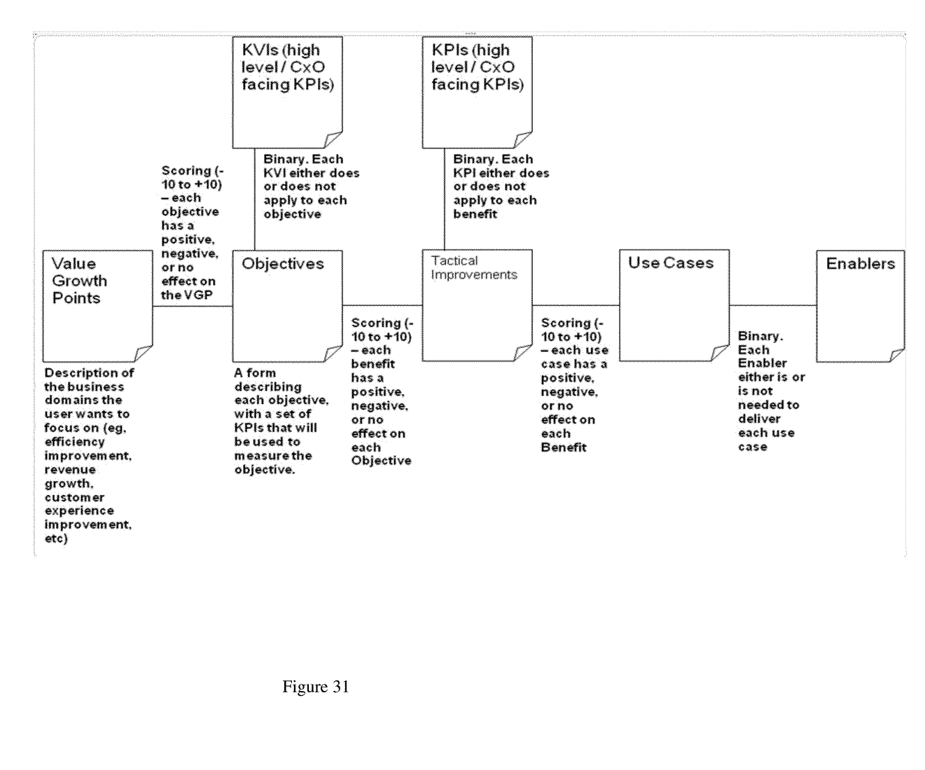

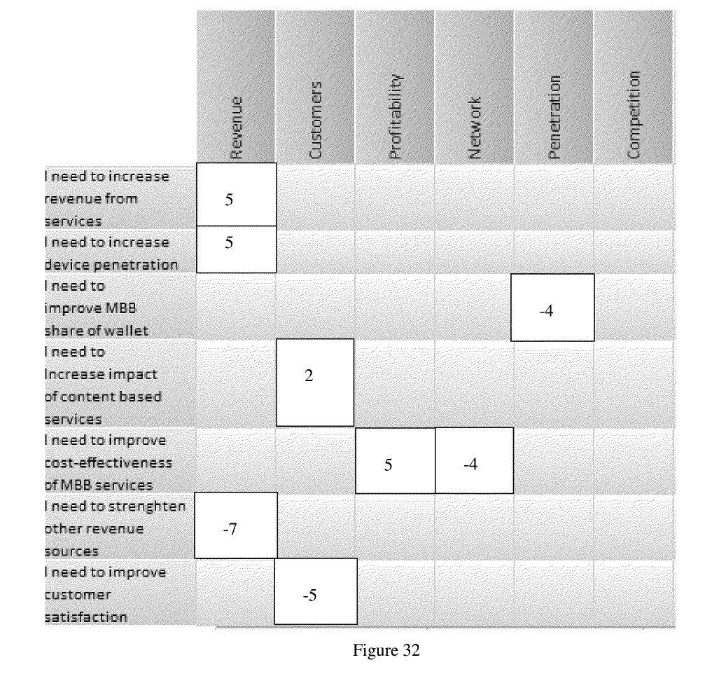

Following is a description of each of the libraries (data bases) that are structured within the relational database element of the application. FIG. 31 is a diagrammatic view of the libraries and their relationships with each other.

A Value growth point is an area of focus for the user (for example, the mobile operator). Value Growth Points are not measured directly by any one KVI, instead they ‘contain’ a set of applicable business objectives below them in the hierarchy.

The relationships between VGPs and Objectives can be one-to-many, one-to-one, or many-to-one. That is, one VGP can contain one or several Objectives, and one Objective can be contained within one or several VGPs. The relationships between VGPs and Objectives can be positive or negative. That is, delivering against an Objective can have a positive or negative impact on the business' performance against a VGP. Consider the Objective to maximize customer base. This can arguably only be achieved by reducing customer value through price reductions, which in turn would damage customer ARPU. So it would have a negative impact on the VGP “Customer Value” but a positive impact on the VGP “market share”.

The impact relationship between VGPs and Objectives is one-directional; that is, a VGP has no impact on achieving any Objectives but an Objective can have an impact on business performance against a VGP.

As shown in Table 2, a VGP includes the following characteristics:

TABLE 2
Characteristics of VGP

| Title | Description |
|---|---|
| Container | A VGP is simply a container of one or more Objectives, |
| | where the associated objectives have either a positive or |
| | negative impact on the VGP. |
| No direct | A VGP is not measured directly by any business KPI. |
| measurement | Instead, performance against a VGP is measured by a score |
| | which is a calculation/aggregation of the KPI performance |
| | against the associated Objectives. |
| Highest | A VGP is the highest element in the hierarchy of elements |
| hierarchical | in the relational database topology as defined in this |
| element | document. |

A VGP in the library may include two things:
A defining statement; and
A list of associated Objectives along with their impact. The impact is an integer score within a range (for example between −10 and +10)

The relationships between VGPs and Objectives are illustrated in the example as shown in FIG. 32. In this diagram, the columns with blue headers represent VGPs, the rows with green headers represent business objectives. The scores indicate the level of positive (green) or negative (red) impact, where an empty cell represents an impact of zero.

A business objective is a business goal/objective that is relevant to the user. An objective is associated to at least one VGP in that it contributes in a negative or positive way to business performance in respect of the VGP. An Objective is defined in business terms (freetext), AND in statistical terms (that is, whether or not the objective is met is measured in terms of KPI performance). Similarly to VGPs, the application contains a set of pre-defined business objectives with pre-set links to VGPs and KVIs, which can be added, removed or updated by an Administrator.

The relationships between Objectives and Tactical Improvements can be one-to-many, one-to-one, or many-to-one. That is, one Objective can be impacted by one or several Tactical Improvements, and one Tactical Improvement can impact one or several business objectives.

The relationships between business objectives and Tactical Improvements can be positive or negative. That is, implementing a Tactical Improvement can have a positive or negative impact on the business' performance against an Objective.

The impact relationship between VGPs and Objectives is one-directional; that is, a business objective has no impact on achieving any Tactical Improvements but a Tactical Improvement can have an impact on business performance against a business objective.

As shown in Table 3, a business objective has the following characteristics:

TABLE 3
Characteristics of business objective

| Title | Description |
|---|---|
| Continuously | Business objectives are dynamic. As the application owner |
| Updated | progresses through more engagements with application |
| | users, they will add new objectives and refine the |
| | relationships between objectives and KVIs/Tactical |
| | Improvements, so the value of the business objectives |
| | library improves over time. The business objectives |
| | library therefore represents the knowledge, experience |
| | and skills gained by the application owner. |
| Measured | Business objectives are associated to KVIs in a binary |
| by KVIs | relationship. A KVI is simply a class of KPI which is of |
| | interest to the operator's senior management (CxO level). |
| Supported by | As far as is possible, the application owner should base |
| case studies | business objectives on real case studies and reference the |
| | case study materials when necessary during discussions |
| | with the user. |

A business objective in the library may include three things:
A defining statement;
A list of associated TIs along with their impact. The impact is an integer score within a range (for example between −10 and +10)
A list of associated KVIs

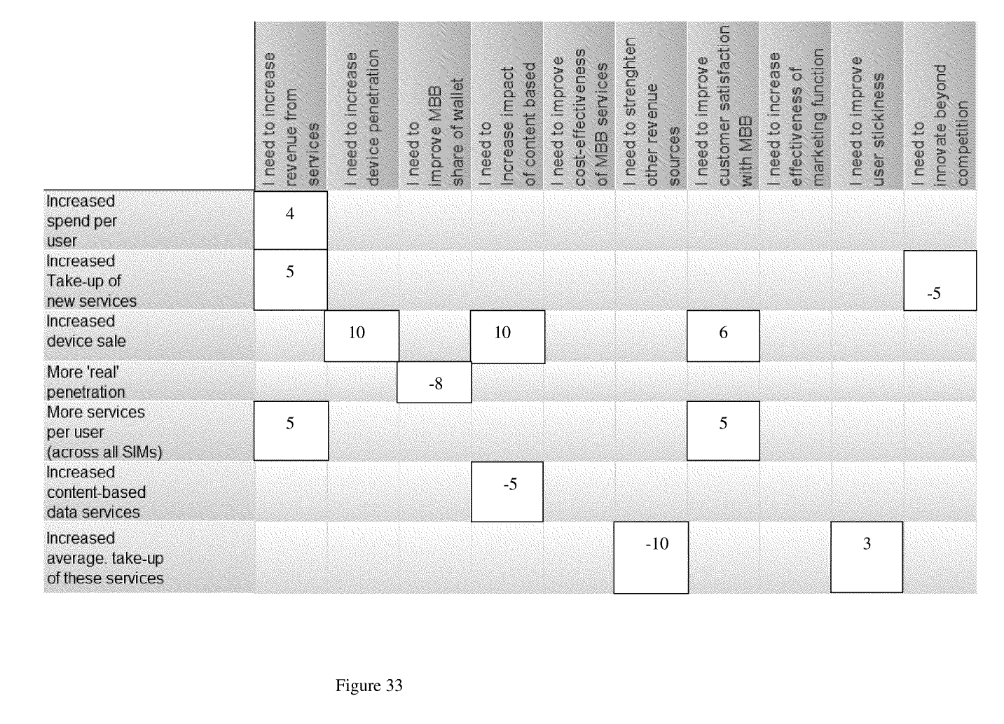

The relationships between business objectives and Tactical Improvements are illustrated in the example as shown in FIG. 33. In this diagram, the columns with blue headers represent business objectives, and the rows with green headers represent Tactical Improvements. The scores indicate the level of positive (green) or negative (red) impact, where an empty cell represents an impact of zero.

A Tactical Improvement is a change in the way the Operator behaves at an operational level. A Tactical Improvement differs from a business objective in that it is completely controllable by the Operator, given the necessary resources, funding and capabilities. A Tactical Improvement is defined in business terms and statistical terms, through KPIs, (as is the case for business objectives). A Tactical Improvement is associated with at least one business objective in that it contributes in a positive or negative way to the measurable performance in respect of the business objective. Similarly to business objectives and VGPs, the application contains a set of pre-defined Tactical Improvements that can be added, removed or updated by an Administrator.

The relationships between Tactical Improvements and use cases can be one-to-many, one-to-one, or many-to-one. That is, one Tactical Improvement can be supported by one or several use cases, and one use case can impact one or several Tactical Improvements.

The relationships between Tactical Improvements and use cases can be positive or negative. That is, implementing a use case can have a positive or negative impact on the business' performance against a Tactical Improvement.

The impact relationship between Tactical Improvements and use cases is one-directional; that is, a Tactical Improvement has no impact on achieving any use cases but a use case can have an impact on business performance against a Tactical Improvement.

As shown in Table 4, a business objective has the following characteristics:

TABLE 4
Characteristics of Tactical Improvement

| Title | Description |
|---|---|
| Continuously | Tactical Improvements are dynamic. As the application |
| Updated | owner progresses through more engagements with |
| | application users, they will add new Tactical Improvements |
| | and refine the relationships between Tactical Improvements |
| | and use cases, so the value of the Tactical Improvements |
| | library improves over time. The Tactical Improvements |
| | library therefore represents the knowledge, experience and |
| | skills gained by the application owner. |
| Measured | Tactical Improvements are associated to KPIs in a binary |
| by KPIs | relationship. A KPI is mainly of interest to the operator's |
| | middle management. |
| Supported by | As far as is possible, the application owner should base |
| Case Studies | tactical improvements on real case studies and reference the |
| | case study materials when necessary during discussions |
| | with the user. The estimates for impact on KPIs should as |
| | far as possible be based on actual results seen from these |
| | case studies. |

A Tactical Improvement in the library may include three things:
A defining statement;
A list of associated use cases along with their impact. The impact is an integer score within a range (for example between −10 and +10)
A list of associated KPIs

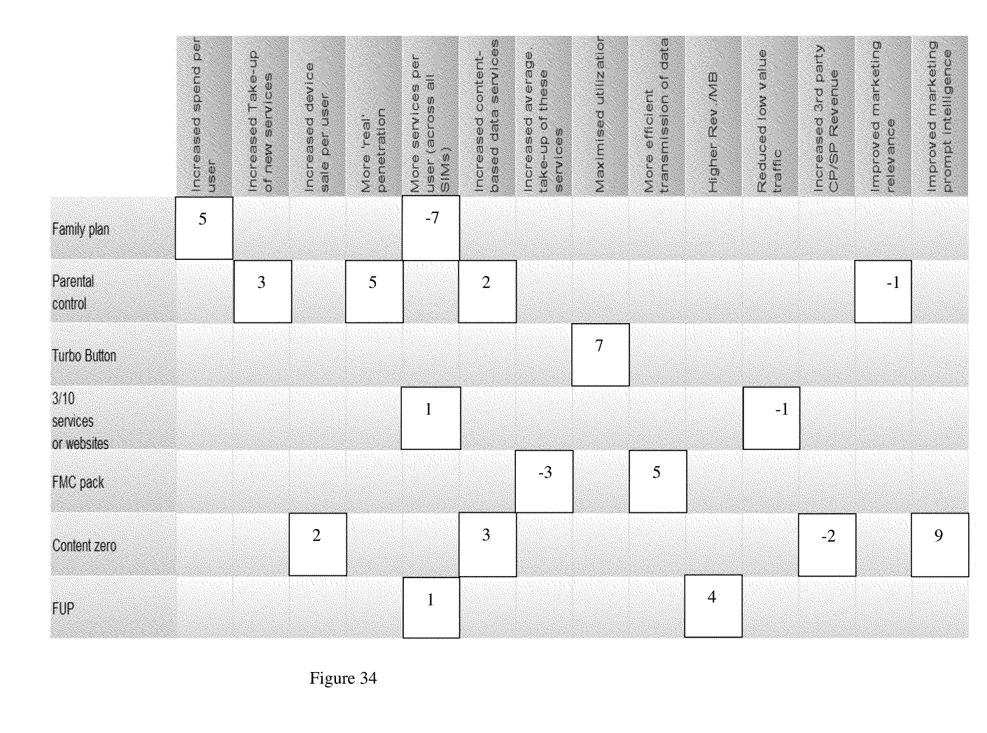

The relationships between Tactical Improvements and use cases are illustrated in the example as shown in FIG. 34. In this diagram, the columns with blue headers represent Tactical Improvements, and the rows with green headers represent Business use cases. The scores indicate the level of positive (green) or negative (red) impact, where an empty cell represents an impact of zero.

A use case is a specific implementation that can be carried out by the user's organization. A use case requires a specific combination of marketing, technical and organizational implementations to realize. A use case is always associated with at least one Tactical Improvement. Similarly to Tactical improvements, business objectives and VGPs, a use case can be added, removed, or updated by the Administrator. A use case consists of a set of characteristics that constitute a product or capability (business or technical). Beyond the use case, the only additional decisions required of the user concern configuration items such as the specific price, quality of service setting, customer segment criteria, etc. This patent application contains details of a common use case Framework.

The relationships between use cases and Enablers can be one-to-many, one-to-one, or many-to-one. That is, one use case can be enabled by one or several Enablers, and one Enabler can enable one or several use cases.

The relationships between use cases and Enablers are binary. That is, implementing a use case either does or does not require any specific Enablers.

As shown in Table 5, a use case has the following characteristics:

TABLE 5
Characteristics of use case

| Title | Description |
|---|---|
| Continuously | Use cases are dynamic. As the application owner progresses |
| Updated | through more engagements with application users, they will |
| | add new use cases, so the value of the use case library |
| | improves over time. The use case library therefore |
| | represents the knowledge, experience and skills gained |
| | by the application owner. Generally speaking though, the |
| | relationships between Enablers and use cases are not |
| | dynamic because the technical components needed to |
| | deploy a use case are unlikely to change. |
| Defined by | Use cases are defined within a structured framework to |
| a structured | allow for rapid like-for-like comparison and easy |
| framework | localization (customization of the use case characteristics) |
| | for each operator/user. |
| Supported by | As far as is possible, the application owner should base |
| case studies | tactical improvements on real case studies and reference the |
| | case study materials when necessary during discussions |
| | with the user. The estimates for impact on KPIs should as |
| | far as possible be based on actual results seen from |
| | these case studies. |
| Binary | An Enabler either is or is not required to support a use case |
| relationships | and therefore (as shown in the example below) the |
| with | relationship is binary. |
| Enablers | |

A use case is structured as a form containing specific fields and categories of information. This framework is described later in this document.

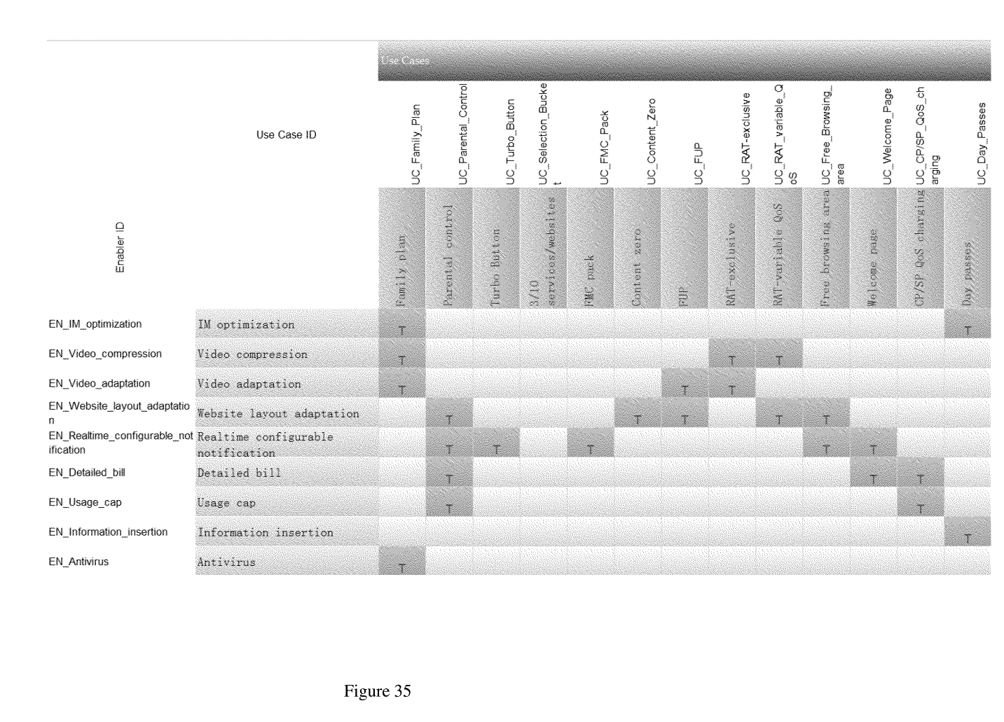

The relationships between use cases and Enablers are illustrated in the example as shown in FIG. 35. In this diagram, the columns with blue headers represent use cases, and the rows with green headers represent Enablers. The cells indicate whether or not the Enabler is required for the use case.

Following is a description of use case definition framework. The relationships between use cases and other elements of the database for this application have been described in previous paragraph. In addition to this, special attention is paid to use cases, in that a use case is not described simply in a largely free text and unstructured way. A use case recommendation is one of the primary outputs of this application, and in order to allow for like for like comparison of use cases by the application user, they may be structured in a common framework, and the framework may specify the relationships between each use case and the Tactical Improvements.

A use case is any implementation of one or more enablers that delivers some business improvement, new capability or new market product. It represents a combination of technology, organizational change, and business activities. A use case may or may not require new technology components to realize (since the user's existing technology components may already provide the required technology enablers).

For the purpose of the application described in this document, use cases may be placed into one of the following categories. These are defined in Table 6 below.

TABLE 6
Types of use cases

| Use Case Type | Definition |
|---|---|
| Market Offers | A product or service deployed in the market. For example, a new |
| | tariff plan, a new Value Added Service or a location-based offer. |
| | Clearly the business equation is primarily based on revenues |
| | received from customers. |
| Enhancements | An enhancement deployed in the market, which impacts customers |
| | automatically and does not itself represent a product or service. For |
| | example, a policy to limit the speed for certain internet traffic types |
| | in order to address congestion. The business equation is potentially |
| | more complicated as it might incorporate network efficiency |
| | directly, and revenues indirectly by changing, for example, the |
| | perceived quality of the network and therefore the attractiveness of |
| | other Market Offers to customers. Another example is the |
| | deployment of an automated account management facility for |
| | customers, which may incorporate call centre cost avoidance, |
| | customer experience, propensity to purchase, promotions |
| | effectiveness and advertising revenues. |
| Business operations | An improvement to the capability, or efficiency, of a business |
| improvement | operation. For example, an automated go-to-market process which |
| | would in turn speed up the Time to Market (TTM) of new offers. |
| | The business equation here is typically straightforward but could be |
| | complicated. Typically, it relates to efficiency, cost avoidance or |
| | savings. But it might also involve competitive issues such as first |
| | mover advantage. |

A use case description template may include two parts:
The description of the use case
The list of relationships between the use case and each Tactical Improvement

The format for the description in the template varies depending on the type of use case (of the three types listed in the table above). But the format for the list of relationships is the same for all three use case types. The following paragraphs detail the complete format for each type.

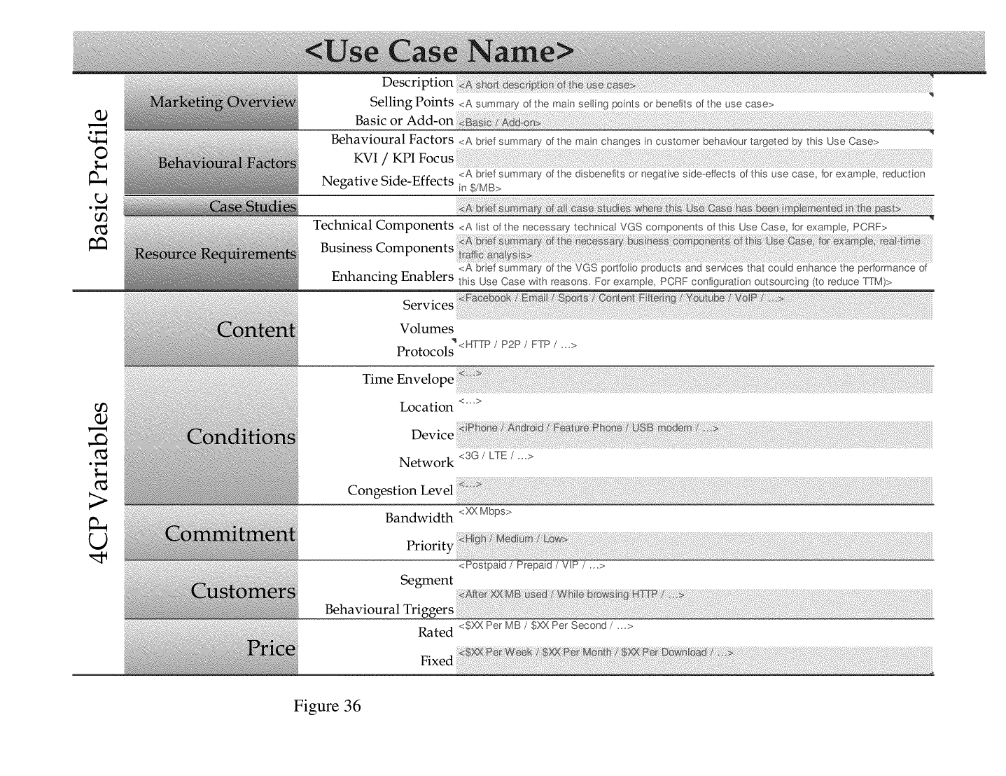

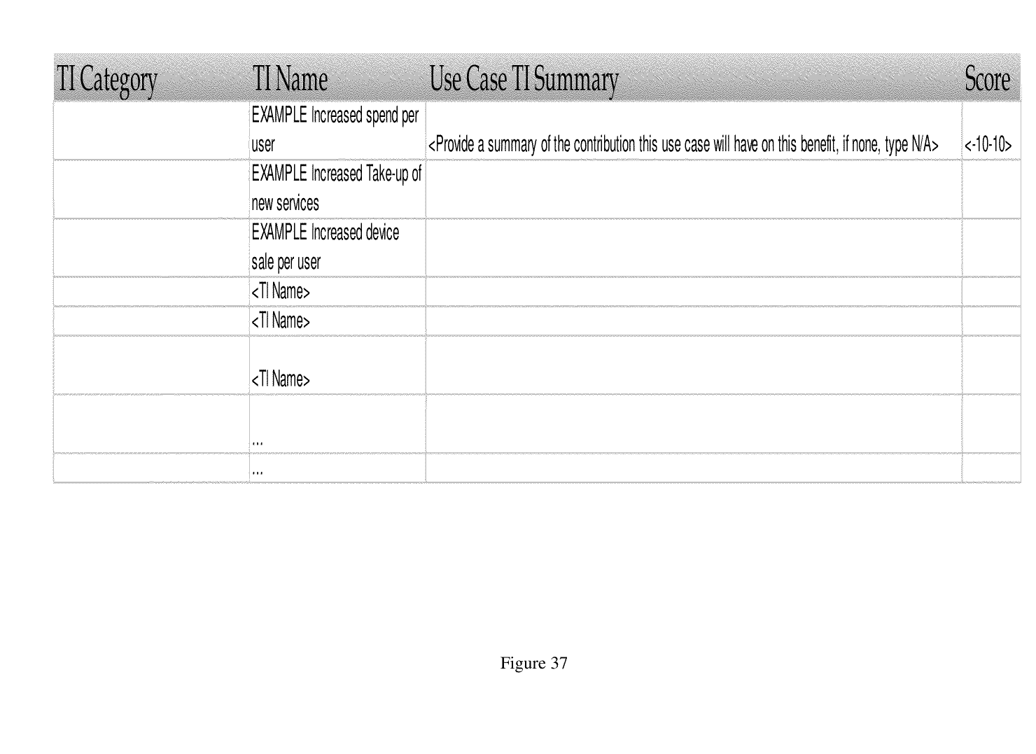

FIGS. 36 and 37 shows a Use Case Template for use cases of Market Offers type. It has three areas of definition:
1. Basic Profile
2. 4CP Variables
3. TI Relationships table (Adding or removing a TI automatically updates the list of TIs in each use case. Updates to TIs are done directly in the TI Library by the Administrator.)

The Basic profile is the ‘at a glance’ view of the use case. It essentially describes the use case in non-technical, unstructured terms, including:
1. Marketing Overview—An overview of the offer:
   a. Description—a short statement describing the market offer in business terms
   b. Selling Points—a summary of the reasons why customers would purchase the offer
   c. Basic or Add-on—whether the offer is part of a basic tariff plan (essential for the customer to use their service) or an add-on (which can be purchased and used in addition to a basic plan.
2. Behavioral Factors—A summary of the behavioral response the market offer is expected to produce:
   a. Behavioral Factors—a short statement describing the expected behavioral response in business terms
   b. KVI/KPI Focus—a short statement summarizing the expected KPI areas that deploying the offer in the market is expected to impact
   c. Negative Side Effects—a short statement summarizing some potential negative impacts the offer may have on the market, such as to put downward pressure on ARPU
3. Case Studies—A list (with attachments) of examples where similar offers have been deployed already around the world
4. Resource Requirements—An overview of the resources/enablers to deliver the offer to the market
   a. Technical Components—a summary of the technical enablers that will be required to deploy this market offer (note, the enabler dependencies are formally defined in the use case to enablers matrix as described above. This list is intended to provide an ‘at a glance’ view to the user.
   b. Business Components—a summary of business enablers, much the same as technical enablers where business enablers are simply a category of enabler.
   c. Enhancing Enablers—a summary of some options available to the user to further enhance the market offer with optional enablers that are not essential. Includes things such as process outsourcing to speed up TTM, or an on-device portal product to simplify customer ordering process.

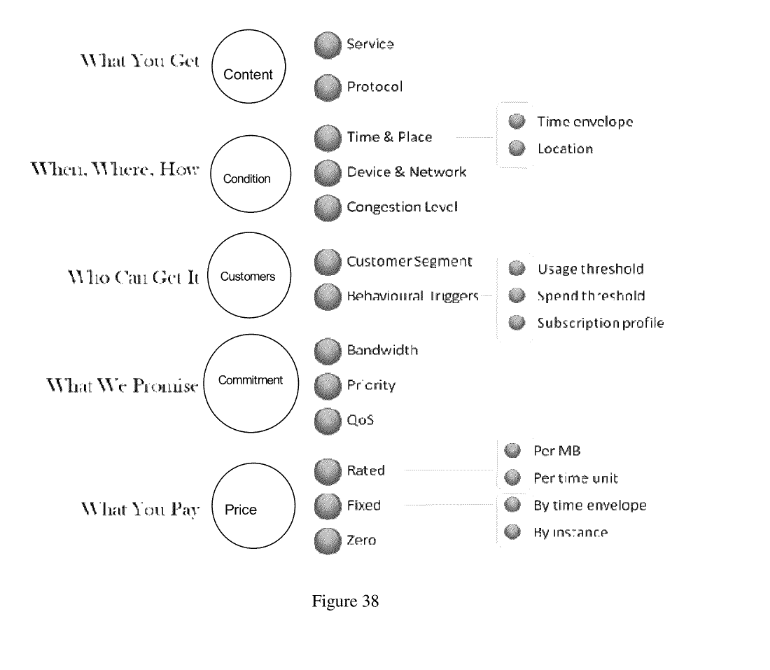

A framework is developed to formally define any market offer in the mobile telecoms industry. Since this is a general definition, there is some flexibility required in the framework. However, this set of five descriptor fields allows for more granular analysis and comparison of the definitions of different use cases. The 4CP framework is illustrated in FIG. 38. Within this framework of five descriptors, further sub-descriptors can be added to create a more complex framework and greater structure, thus allowing for yet more fine granular analysis and comparison. These 4CP variables are described below:
1. Content—A summary of the products/services that comprise the market offer:
   a. Services—The services such as websites, VAS services, music downloads, etc.
   b. Volumes—Any specification of maximum volumes
   c. Protocols—Any specification of protocol types such as P2P
2. Conditions—The conditions, if any, under which the offer is valid for customers
   a. Time Envelope—Any applicable time period such as 7 pm-7 am, Sundays, etc.
   b. Location—Any specification of location exclusions such as only in Moscow central, etc. (in a mobile telecoms context this relates to the cell sites that the customer connects to)
   c. Device—Any specific included device types such as smartphones, Samsung phones, etc (in a mobile telecoms context this relates to the device types that can be detected by the network)
   d. Network—Any specific network standard such as 3G, LTE etc.
   e. Congestion Level—Any limits on the current congestion status of the network
3. Commitment—A summary of any service level commitment that is included in the offer
   a. Bandwidth—Any bandwidth commitment if applicable (such as minimum 256 KB, maximum 1 MB, etc)
   b. Priority—Any specific priority the customer will be given over other customers in situations of congestion
4. Customers—A summary of the customer types the offer is limited to, if any
   a. Segment—Any segment of customer that is a function of historical customer behavior or demographics.
   b. Behavioral Triggers—Any triggers in the usage patterns of customers that must be activated for the customer to receive the offer and/or for the offer to be active
5. Price—A summary of the pricing specification of the offer. Note, this relates more to the pricing structure, and not the actual price levels. However the administrator is free to add any specific details they choose in here.
   a. Rated—Any volume based rated pricing (for example, rated per download, per minute, per MB, etc)
   b. Fixed—Any term based pricing (for example, fixed per month, per week, one-off fixed price)

The table of TI relationships provides the user with more than a matrix showing the expected strength of impact of the use case on each TI. It provides a justification alongside this in plain business language.

As shown in FIG. 37, there are 4 headers in this table of TI relationships. All of the information to populate this table in the use case description is taken from the TI Library, with the exception of the score itself, which is specified in the use case description and in turn populates the TI Library. When the Administrator adds a new TI in the TI Library, every use case description will be automatically updated to include the new TI. The 4 headers are as following:
1. TI Category—Any category can be assigned to a TI, the purpose of categorization is to simplify comparing & contrasting different Tis. Taken from the TI Library
2. TI Name—The Name of the TI, which is taken from the TI Library
3. Use \case TI Summary—A description of the impact the use case has on the ability to realize the TI, expressed in simple business terms. Taken from the TI Library
4. Score—A score between −10 and 10 to show the extent of impact the use case will have on the TI.

Use case template of Market Enhancement type is structured in a similar way to Market Offers type, except that they do not contain the 4CP framework part, and they include some changes in the Basic Profile part. A Market Enhancement type can be deployed a lot of ways, and therefore the Market Enhancement does not lend itself to a structured variables framework, as in the case of Market Offers.

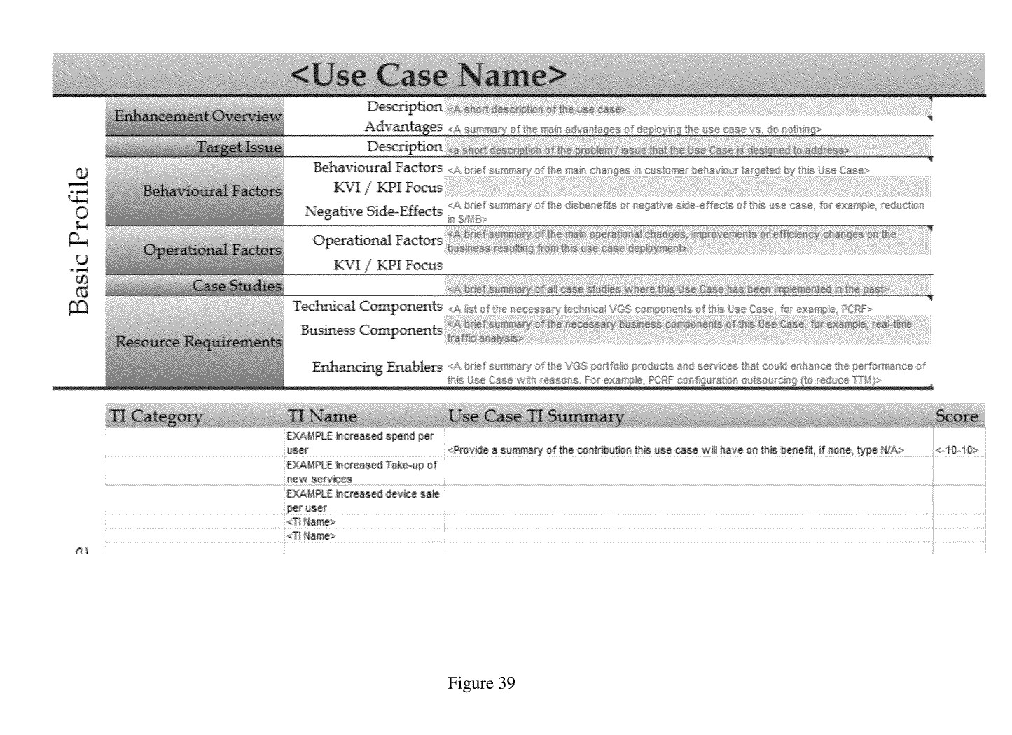

FIG. 39 shows a Use Case Template for use cases of Market Enhancement type. It has two areas of definition:
1. Basic Profile
2. TI Relationships table

The Basic profile is the ‘at a glance’ view of the use case. It essentially describes the use case in non-technical, unstructured terms, including:
1. Enhancement Overview—An overview of the offer:
   a. Description—a short statement describing the market enhancement in business terms
   b. Advantages—a short statement describing the main advantages of deploying this use case vs. not deploying it.
2. Target Issue—a short summary of the existing problem, inefficiency or issue that this use case is primarily designed to address.
3. Behavioral Factors—an overview of the types of customer behavior change that are expected as a result of deploying this use case (if any). For details of the sub-headings, see the description of Market Offers above.
4. Operational Factors—A summary of the main operational changes, improvements or efficiency changes in the business resulting from the use case deployment
   a. Operational Factors—A summary of the main operational changes, improvements or efficiency changes in the business resulting from the use case deployment
   b. KVI/KPI Focus—a short statement summarizing the expected KPI areas that deploying the use case is expected to impact, in the area of business operations
5. Case Studies—A list (with attachments) of examples where similar enhancements have been deployed already around the world.
6. Resource Requirements—An overview of the resources/enablers required to deploy the enhancement. For details please see the description of Market Offers above.

TI Relationships table of the use case template for market enhancements works in exactly the same way as the use case template for market offers. Please see the market offers description for details.

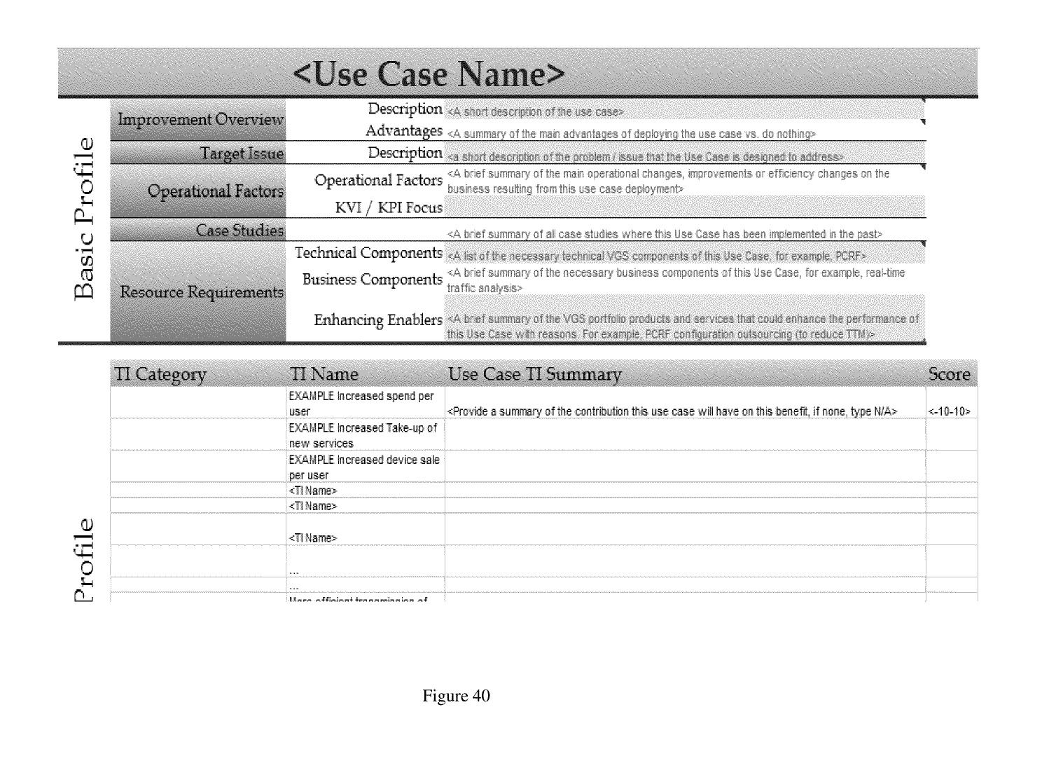

FIG. 40 shows a Use Case Template for use cases of Business Operations Improvement type. It has two areas of definition:
1. Basic Profile
2. TI Relationships table

The Basic profile is the ‘at a glance’ view of the use case. It essentially describes the use case in non-technical, unstructured terms, including:
1. Improvement Overview—An overview of the business operations improvement:
   a. Description—A short description of the improvement
   b. Advantages—A summary of the main advantages of deploying the improvement vs. not doing anything
2. Case Studies—A list (with attachments) of examples where deployments have been completed already around the world
3. Resource Requirements—An overview of the resources/enablers required to deploy the enhancement. For details please see the description of Market Offers above.

TI Relationships table of the use case template for business operations improvement works in exactly the same way as the use case template for market offers. Please see the market offers description for details.

Persons of ordinary skill in the art should understand that all or part of the subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

Finally, it should be understood that the above embodiments are only used to explain, but not to limit the technical solution of the present application. Despite the detailed description of the present application with reference to above preferred embodiments, it should be understood that various modifications, changes or equivalent replacements can be made by those skilled in the art without departing from the scope of the present application and covered in the claims of the present application.

What is claimed is:

1. A computer system for obtaining an optimized combination of use cases for a communication network, comprising:
a memory storing a computer executable program that includes a front end module and an optimization engine, the memory also storing an objective database, a use case database and an evaluation information database;
a processor coupled with the memory and configured to execute the program;
a display controlled by the processor to display a graphic interaction interface; and
an input device to obtain an input and provide the input to the processor; and
wherein the front end module causes the processor to perform the steps of presenting on the display, a set of objectives from the objective database, wherein the set of objectives is associated with a communication network indicator with respect to the communication network, and each of objectives is measurable with a set of key performance indicators (KPI); and
receiving a selection to one or more objectives from the presented set of objectives through the input device;
wherein the optimization engine causes the processor to perform the step of outputting a first optimized combination of use cases from the use case database having the most positive impact to KPIs of the selected set of objectives, according to the selected set of objectives from the front end module, the use case database and the evaluation information database, wherein evaluation information in the evaluation information database indicates an impact of each use case on each of the KPIs of the selected set of objectives; and
wherein the front end module causes the processor to perform the further step of presenting on the display the first optimized combination of use cases output from the optimization engine.

2. The computer system according to claim 1, wherein the set of objectives comprises a Tactical Improvement (TI) associated with an operational level indicator of the communication network, controllable by an operator of the communication network, and wherein the set of KPIs used to measure each of the at least one TI comprises a set of Tactical KPIs.

3. The computer system according to claim 1, wherein the set of objectives comprises a business objective (BO) associated with a business indicator of the communication network, wherein the set of KPIs used to measure each of the at least one BO comprises a set of Key Value Indicators (KVI).

4. The computer system according to claim 3, wherein the BO corresponds to a stored Tactical Improvement (TI) associated with an operational level indicator of the communication network controllable by an operator of the communication network, and the BO is measurable with a set of Tactical KPIs;
wherein the front end module is further configured to cause the processor to perform the steps of presenting on the display TIs corresponding to the selected BOs; and receiving a selection to one or more TIs from the presented TIs through the input device; and
wherein the step of outputting the first optimized combination of use cases comprises outputting the first optimized combination of use cases having the most positive impact to KVIs of the selected BOs, according to the selected BOs and the selected TIs from the front end module, the use case database and the evaluation information database, wherein the evaluation information in the evaluation information database specifically indicates an impact of each use case on each of the KPIs of the selected TIs, and an impact of each of the Tactical KPIs of the selected TIs on each of the KVIs of the selected BOs.

5. The computer system according to claim 4, wherein the optimization engine causes the processor to perform the step of:
generating a data tree with the KVIs of the selected BOs at the root level and the Tactical KPIs of the selected TIs at the branch level, according to the evaluation information database, wherein each of the KVIs is linked to constituent KPIs by a formula such that the degree of improvement of KVI is a function of degree of improvement of KPI;
calculating impacts of combinations of use cases on KVIs of the selected BOs, according to the data tree and the evaluation information database; and
outputting the combination of use cases having the most positive impact on KVIs of the selected BOs from the calculated combinations of use cases.

6. The computer system according to claim 1, wherein the front end module is further configured to cause the processor to perform the steps of presenting on the display a set of value growth points (VGP), wherein each of the set of VGPs corresponds to at least one stored objective, and receiving a selection to one or more VGPs from the presented set of VGPs through the input device; and
wherein the step of presenting on the display the set of objectives from the objective database comprises presenting on the display objectives corresponding to the selected VGPs.

7. The computer system according to claim 1, wherein the front end module is further configured to cause the processor to perform the step of receiving ranking to the selected set of objectives through the input device; and
wherein the optimization engine causes the processor to perform the step of outputting the first optimized combination of use cases having the most positive impact to KPIs of the selected set of objectives, according to the selected set of objectives from the front end module, the ranking to the selected set of objectives, the use case database and the evaluation information database.

8. The computer system according to claim 1, wherein the optimization engine causes the processor to perform the steps of:
calculating impact of each use case to the KPIs of the selected set of objectives according to the evaluation information database; and
outputting any use case with a positive impact to the KPIs of the selected set of objectives.

9. The computer system according to claim 1, wherein the memory is further configured to store an objective filtering module, wherein the objective filtering module is configured to cause the processor to perform the steps of receiving through a communication interface of the computer, information of the communication network from an information gathering device of the communication network; and outputting a set of objectives corresponding to the received information of the communication network; and
wherein the step of presenting on the display the set of objectives from the objective database comprises presenting on the display the set of objectives output by the objective filtering module.

10. The computer system according to claim 1, wherein the front end module is further configured to cause the processor to perform the step of presenting a set of enablers corresponding to the optimized use cases combination, wherein an enabler in the set of the enablers indicates an operational or technical capability for implementing a use case of the optimized use case s combination.

11. The computer system according to claim 10, wherein the front end module is further configured to cause the processor to perform the steps of:
receiving a selection or de-selection to one or more enablers from the presented set of enablers through the input device; and
highlighting on the display any objective in the selected set of objectives and/or any use case in the optimized use cases combination influenced by the selection or de-selection.

12. The computer system according to claim 11, wherein the optimization engine is further configured to cause the processor to perform the step of outputting a second optimized combination of use cases having the most positive impact to KPIs of the selected set of objectives, according to the selected set of objectives from the front end module, the use case database, the use cases influenced by the selection or de-selection and the evaluation information database; and
wherein the front end module is configured to cause the processor to perform the step of presenting on the display, by the front end module, the second optimized use cases combination output from the optimization engine.

13. A non-transitory computer readable media containing code for obtaining an optimized combination of use cases for a communication network, which when executed by a computer performs the steps of:
presenting on a display, a set of objectives from an objective database, wherein the set of objectives is associated to at least one communication network indicator with respect to the communication network, and each of the set of objectives is measurable with a set of key performance indicator (KPI)s;
receiving a selection to one or more objectives from the presented set of objectives through an input device;
outputting a first optimized combination of use cases from the use case database having the most positive impact to KPIs of the selected set of objectives, according to the selected set of objectives, the use case database and the evaluation information database; wherein evaluation information in the evaluation information database indicates an impact of each use case on each of the KPIs of the selected set of objectives; and
presenting on the display the optimized use cases combination.

14. A method implemented by a computer for obtaining an optimized combination of use cases for a communication network, the method comprising:
presenting on a display device a set of objectives, wherein at least one communication network indicator is associated with the set of objectives, and each of the set of objectives is measurable by a set of key performance indicators (KPI);
receiving a selection to one or more objectives from the presented set of objectives through an input device;
outputting a first optimized combination of use cases having the most positive impact to KPIs of the selected set of objectives, according to the selected set of objectives, a set of stored use cases and stored evaluation information; wherein the evaluation information indicates an impact of each of the stored use cases on each of the KPIs of the selected set of objectives; and
presenting on the display the first optimized combination of use cases.

15. The method according to claim 14, wherein the set of objectives comprises at least one Tactical Improvement (TI) objective associated with an operational level indicator of the communication network, controllable by an operator of the communication network, and wherein the set of KPIs used to measure each of the at least one TI objective comprises a set of Tactical KPIs.

16. The method according to claim 14, wherein the set of objectives comprises at least one business objective (BO) associated with a business indicator of the communication network, wherein the set of KPIs used to measure each of the at least one BO comprises a set of Key Value Indicator (KVI)s.

17. The method according to claim 16, wherein each of the at least one BO corresponds to at least one stored Tactical Improvement (TI) objective associated with an operational level indicator of the communication network controllable by an operator of the communication network, and the each of the at least one BO is measurable with a set of Tactical KPIs;
wherein before the step of outputting the first optimized combination of use cases, and after the step of receiving the selection to the presented set of the objectives, the method further comprises presenting on the display, a set of TI objectives corresponding to the selected BOs, and receiving a selection to one or more TI objectives from the presented TIs through the input device; and
wherein the step of outputting the first optimized combination of use cases comprises outputting the first optimized combination of use cases having the most positive impact to KVIs of the selected BOs, according to the selected BOs and the selected TI objectives, the set of stored use cases and the stored evaluation information, wherein the stored evaluation information specifically indicates an impact of each of the stored use cases on each of the KPIs of the selected TI objectives, and an impact of each of the Tactical KPIs of the selected TI objectives on each of the KVIs of the selected BOs.

18. The method according to claim 14, wherein before the step of presenting on the display the set of objectives, the method further comprises presenting on the display, a set of value growth points (VGP), wherein each of the set of VGPs corresponds to at least one stored objective; and receiving a selection to one or more VGPs from the presented set of VGPs through the input device; and
wherein the presenting on the display the set of objectives comprises presenting on the display objectives corresponding to the selected VGPs.

19. The method according to claim 14, wherein before the step of outputting the first optimized combination of use cases, the method further comprises receiving ranking to the selected set of objectives through the input device; and
wherein the step of outputting the first optimized combination of use cases comprises outputting the first optimized combination of use cases having the most positive impact to KPIs of the selected set of objectives, according to the selected set of objectives, the ranking to the selected set of objectives, the set of stored use cases and the stored evaluation information.

20. The method according to claim 14, wherein the step of outputting the first optimized combination of use cases comprises:
calculating impact of each use case on the KPIs of the selected set of objectives according to the evaluation information; and
outputting any use case with a positive impact on the KPIs of the selected set of objectives.
